(19) United States
(12) Patent Application Publication
(10) Pub. No.: US 2025/0199619 A1
(43) Pub. Date: Jun. 19, 2025

(54) TECHNIQUES FOR CONTROLLING DEVICES

(71) Applicant: Apple Inc., Cupertino, CA (US)

(72) Inventors: Adam S. MEYER, Cupertino, CA (US); Peter C. TSOI, San Mateo, CA (US)

(21) Appl. No.: 18/644,507

(22) Filed: Apr. 24, 2024

Related U.S. Application Data
(60) Provisional application No. 63/611,069, filed on Dec. 15, 2023.

(51) Int. Cl. G06F 3/01

(52) U.S. Cl. CPC G06F 3/017; G06F 3/011

(57) ABSTRACT

The present disclosure generally relates to controlling devices.

### CROSS-REFERENCE TO RELATED APPLICATIONS

The present application claims priority to U.S. Provisional Patent Application Ser. No. 63/611,069 entitled “TECHNIQUES FOR CONTROLLING DEVICES” filed Dec. 15, 2023, which is hereby incorporated by reference in its entirety for all purposes.

### FIELD

The present disclosure relates generally to computer user interfaces, and more specifically to techniques for controlling devices.

### BACKGROUND

Electronic devices are sometimes controlled using a gesture. For example, a subject can perform a gesture to control an electronic device.

### SUMMARY

Some techniques for controlling devices using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for controlling devices. Such methods and interfaces optionally complement or replace other methods for controlling devices. Such methods and interfaces reduce the cognitive burden on a user and produce a more efficient human-machine interface. For battery-operated computing devices, such methods and interfaces conserve power and increase the time between battery charges.

In some embodiments, a method that is performed at a first computer system that is in communication with one or more input devices is described. In some embodiments, the method comprises: detecting, via the one or more input devices, a first air gesture; and in response to detecting the first air gesture: in accordance with a determination that the first air gesture is performed relative to a first surface, changing a first setting of a control; in accordance with a determination that the first air gesture is performed relative to a second surface different from the first surface, changing the first setting of the control; and in accordance with a determination that the first air gesture is performed relative to a third surface different from the first surface and the second surface, forgoing changing the first setting of the control.

In some embodiments, a non-transitory computer-readable storage medium storing one or more programs configured to be executed by one or more processors of a first computer system that is in communication with one or more input devices is described. In some embodiments, the one or more programs includes instructions for: detecting, via the one or more input devices, a first air gesture; and in response to detecting the first air gesture: in accordance with a determination that the first air gesture is performed relative to a first surface, changing a first setting of a control; in accordance with a determination that the first air gesture is performed relative to a second surface different from the first surface, changing the first setting of the control; and in accordance with a determination that the first air gesture is performed relative to a third surface different from the first surface and the second surface, forgoing changing the first setting of the control.

In some embodiments, a transitory computer-readable storage medium storing one or more programs configured to be executed by one or more processors of a first computer system that is in communication with one or more input devices is described. In some embodiments, the one or more programs includes instructions for: detecting, via the one or more input devices, a first air gesture; and in response to detecting the first air gesture: in accordance with a determination that the first air gesture is performed relative to a first surface, changing a first setting of a control; in accordance with a determination that the first air gesture is performed relative to a second surface different from the first surface, changing the first setting of the control; and in accordance with a determination that the first air gesture is performed relative to a third surface different from the first surface and the second surface, forgoing changing the first setting of the control.

In some embodiments, a first computer system that is in communication with one or more input devices is described. In some embodiments, the first computer system that is in communication with one or more input devices comprises one or more processors and memory storing one or more programs configured to be executed by the one or more processors. In some embodiments, the one or more programs includes instructions for: detecting, via the one or more input devices, a first air gesture; and in response to detecting the first air gesture: in accordance with a determination that the first air gesture is performed relative to a first surface, changing a first setting of a control; in accordance with a determination that the first air gesture is performed relative to a second surface different from the first surface, changing the first setting of the control; and in accordance with a determination that the first air gesture is performed relative to a third surface different from the first surface and the second surface, forgoing changing the first setting of the control.

In some embodiments, a first computer system that is in communication with one or more input devices is described. In some embodiments, the first computer system that is in communication with one or more input devices comprises means for performing each of the following steps: detecting, via the one or more input devices, a first air gesture; and in response to detecting the first air gesture: in accordance with a determination that the first air gesture is performed relative to a first surface, changing a first setting of a control; in accordance with a determination that the first air gesture is performed relative to a second surface different from the first surface, changing the first setting of the control; and in accordance with a determination that the first air gesture is performed relative to a third surface different from the first surface and the second surface, forgoing changing the first setting of the control.

In some embodiments, a computer program product is described. In some embodiments, the computer program product comprises one or more programs configured to be executed by one or more processors of a first computer system that is in communication with one or more input devices. In some embodiments, the one or more programs include instructions for: detecting, via the one or more input devices, a first air gesture; and in response to detecting the first air gesture: in accordance with a determination that the first air gesture is performed relative to a first surface, changing a first setting of a control; in accordance with a determination that the first air gesture is performed relative to a second surface different from the first surface, changing the first setting of the control; and in accordance with a determination that the first air gesture is performed relative to a third surface different from the first surface and the second surface, forgoing changing the first setting of the control.

In some embodiments, a method that is performed at a computer system that is in communication with one or more input devices is described. In some embodiments, the method comprises: detecting, via the one or more input devices, a first input directed to a control associated with a first device and a second device different from the first device; and in response to detecting the first input: in accordance with a determination that the first input is in a first direction, causing the first device to perform an operation without causing the second device to perform an operation; and in accordance with a determination that the first input is in a second direction different from the first direction, causing the second device to perform an operation without causing the first device to perform an operation.

In some embodiments, a non-transitory computer-readable storage medium storing one or more programs configured to be executed by one or more processors of a computer system that is in communication with one or more input devices is described. In some embodiments, the one or more programs includes instructions for: detecting, via the one or more input devices, a first input directed to a control associated with a first device and a second device different from the first device; and in response to detecting the first input: in accordance with a determination that the first input is in a first direction, causing the first device to perform an operation without causing the second device to perform an operation; and in accordance with a determination that the first input is in a second direction different from the first direction, causing the second device to perform an operation without causing the first device to perform an operation.

In some embodiments, a transitory computer-readable storage medium storing one or more programs configured to be executed by one or more processors of a computer system that is in communication with one or more input devices is described. In some embodiments, the one or more programs includes instructions for: detecting, via the one or more input devices, a first input directed to a control associated with a first device and a second device different from the first device; and in response to detecting the first input: in accordance with a determination that the first input is in a first direction, causing the first device to perform an operation without causing the second device to perform an operation; and in accordance with a determination that the first input is in a second direction different from the first direction, causing the second device to perform an operation without causing the first device to perform an operation.

In some embodiments, a computer system that is in communication with one or more input devices is described. In some embodiments, the computer system that is in communication with one or more input devices comprises one or more processors and memory storing one or more programs configured to be executed by the one or more processors. In some embodiments, the one or more programs includes instructions for: detecting, via the one or more input devices, a first input directed to a control associated with a first device and a second device different from the first device; and in response to detecting the first input: in accordance with a determination that the first input is in a first direction, causing the first device to perform an operation without causing the second device to perform an operation; and in accordance with a determination that the first input is in a second direction different from the first direction, causing the second device to perform an operation without causing the first device to perform an operation.

In some embodiments, a computer system that is in communication with one or more input devices is described. In some embodiments, the computer system that is in communication with one or more input devices comprises means for performing each of the following steps: detecting, via the one or more input devices, a first input directed to a control associated with a first device and a second device different from the first device; and in response to detecting the first input: in accordance with a determination that the first input is in a first direction, causing the first device to perform an operation without causing the second device to perform an operation; and in accordance with a determination that the first input is in a second direction different from the first direction, causing the second device to perform an operation without causing the first device to perform an operation.

In some embodiments, a computer program product is described. In some embodiments, the computer program product comprises one or more programs configured to be executed by one or more processors of a computer system that is in communication with one or more input devices. In some embodiments, the one or more programs include instructions for: detecting, via the one or more input devices, a first input directed to a control associated with a first device and a second device different from the first device; and in response to detecting the first input: in accordance with a determination that the first input is in a first direction, causing the first device to perform an operation without causing the second device to perform an operation; and in accordance with a determination that the first input is in a second direction different from the first direction, causing the second device to perform an operation without causing the first device to perform an operation.

In some embodiments, a method that is performed at a computer system that is in communication with one or more input devices is described. In some embodiments, the method comprises: while the computer system is operating in a first mode: detecting, via the one or more input devices, a first input directed to a first location on a first surface; in response to detecting the first input directed to the first location on the first surface, causing a first device to perform a first operation, wherein the first device is different from the computer system; and after causing the first device to perform the first operation, detecting, via the one or more input devices, a second input including an air gesture; in response to detecting the second input, switching to operating from the first mode to a second mode different from the first mode; and while the computer system is operating in the second mode: detecting, via the one or more input devices, a third input directed to the first location on the first surface; and in response to detecting the third input directed to the first location on the first surface, causing a second device to perform a second operation, wherein the second device is different from the computer system and the first device.

In some embodiments, a non-transitory computer-readable storage medium storing one or more programs configured to be executed by one or more processors of a computer system that is in communication with one or more input devices is described. In some embodiments, the one or more programs includes instructions for: while the computer system is operating in a first mode: detecting, via the one or more input devices, a first input directed to a first location on a first surface; in response to detecting the first input directed to the first location on the first surface, causing a first device to perform a first operation, wherein the first device is different from the computer system; and after causing the first device to perform the first operation, detecting, via the one or more input devices, a second input including an air gesture; in response to detecting the second input, switching to operating from the first mode to a second mode different from the first mode; and while the computer system is operating in the second mode: detecting, via the one or more input devices, a third input directed to the first location on the first surface; and in response to detecting the third input directed to the first location on the first surface, causing a second device to perform a second operation, wherein the second device is different from the computer system and the first device.

In some embodiments, a transitory computer-readable storage medium storing one or more programs configured to be executed by one or more processors of a computer system that is in communication with one or more input devices is described. In some embodiments, the one or more programs includes instructions for: while the computer system is operating in a first mode: detecting, via the one or more input devices, a first input directed to a first location on a first surface; in response to detecting the first input directed to the first location on the first surface, causing a first device to perform a first operation, wherein the first device is different from the computer system; and after causing the first device to perform the first operation, detecting, via the one or more input devices, a second input including an air gesture; in response to detecting the second input, switching to operating from the first mode to a second mode different from the first mode; and while the computer system is operating in the second mode: detecting, via the one or more input devices, a third input directed to the first location on the first surface; and in response to detecting the third input directed to the first location on the first surface, causing a second device to perform a second operation, wherein the second device is different from the computer system and the first device.

In some embodiments, a computer system that is in communication with one or more input devices is described. In some embodiments, the computer system that is in communication with one or more input devices comprises one or more processors and memory storing one or more programs configured to be executed by the one or more processors. In some embodiments, the one or more programs includes instructions for: while the computer system is operating in a first mode: detecting, via the one or more input devices, a first input directed to a first location on a first surface; in response to detecting the first input directed to the first location on the first surface, causing a first device to perform a first operation, wherein the first device is different from the computer system; and after causing the first device to perform the first operation, detecting, via the one or more input devices, a second input including an air gesture; in response to detecting the second input, switching to operating from the first mode to a second mode different from the first mode; and while the computer system is operating in the second mode: detecting, via the one or more input devices, a third input directed to the first location on the first surface; and in response to detecting the third input directed to the first location on the first surface, causing a second device to perform a second operation, wherein the second device is different from the computer system and the first device.

In some embodiments, a computer system that is in communication with one or more input devices is described. In some embodiments, the computer system that is in communication with one or more input devices comprises means for performing each of the following steps: while the computer system is operating in a first mode: detecting, via the one or more input devices, a first input directed to a first location on a first surface; in response to detecting the first input directed to the first location on the first surface, causing a first device to perform a first operation, wherein the first device is different from the computer system; and after causing the first device to perform the first operation, detecting, via the one or more input devices, a second input including an air gesture; in response to detecting the second input, switching to operating from the first mode to a second mode different from the first mode; and while the computer system is operating in the second mode: detecting, via the one or more input devices, a third input directed to the first location on the first surface; and in response to detecting the third input directed to the first location on the first surface, causing a second device to perform a second operation, wherein the second device is different from the computer system and the first device.

In some embodiments, a computer program product is described. In some embodiments, the computer program product comprises one or more programs configured to be executed by one or more processors of a computer system that is in communication with one or more input devices. In some embodiments, the one or more programs include instructions for: while the computer system is operating in a first mode: detecting, via the one or more input devices, a first input directed to a first location on a first surface; in response to detecting the first input directed to the first location on the first surface, causing a first device to perform a first operation, wherein the first device is different from the computer system; and after causing the first device to perform the first operation, detecting, via the one or more input devices, a second input including an air gesture; in response to detecting the second input, switching to operating from the first mode to a second mode different from the first mode; and while the computer system is operating in the second mode: detecting, via the one or more input devices, a third input directed to the first location on the first surface; and in response to detecting the third input directed to the first location on the first surface, causing a second device to perform a second operation, wherein the second device is different from the computer system and the first device.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for controlling devices, thereby increasing the effectiveness, efficiency, and user satisfaction with such devices. Such methods and interfaces may complement or replace other methods for controlling devices.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1 is a block diagram illustrating an electronic device in accordance with some embodiments.

FIGS. 2A-2D illustrate techniques for responding to air gestures performed relative to surfaces in accordance with some embodiments.

FIG. 3 is a flow diagram illustrating a method for responding to input in accordance with some embodiments.

FIG. 4 is a flow diagram illustrating a method for responding to input in accordance with some embodiments.

FIG. 5 is a flow diagram illustrating a method for responding to input in accordance with some embodiments.

### DETAILED DESCRIPTION

The following description sets forth exemplary methods, parameters, and the like. It should be recognized, however, that such description is not intended as a limitation on the scope of the present disclosure but is instead provided as a description of exemplary examples.

There is a need for electronic devices that provide efficient methods and interfaces for controlling devices using gestures. For example, an air gesture can cause different operations to be performed depending on which subject performs the air gesture. For another example, the same air gesture can be used in different modes to either transition modes and/or change content being output. For another example, different types of moving air gestures can cause different operations to be performed. Such techniques can reduce the cognitive burden on a user using an electronic device, thereby enhancing productivity. Further, such techniques can reduce processor and battery power otherwise wasted on redundant user inputs.

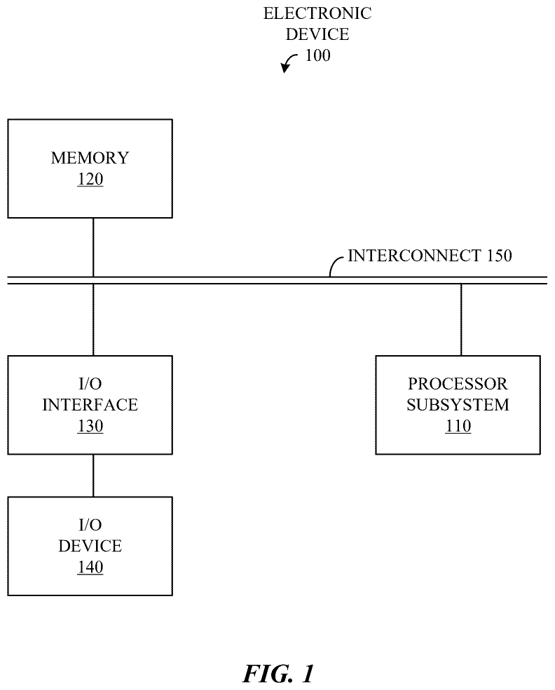

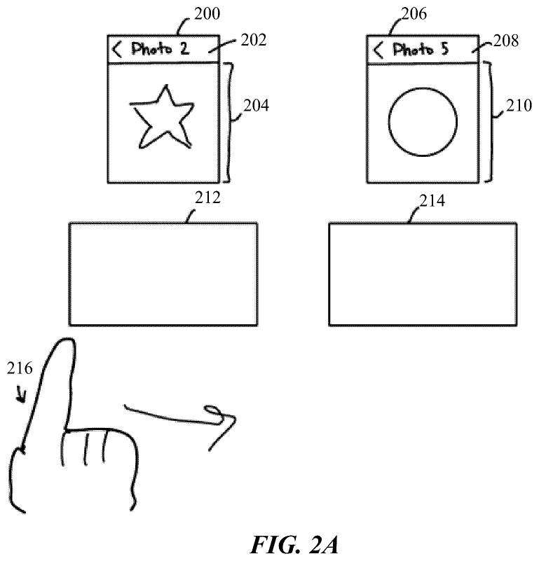

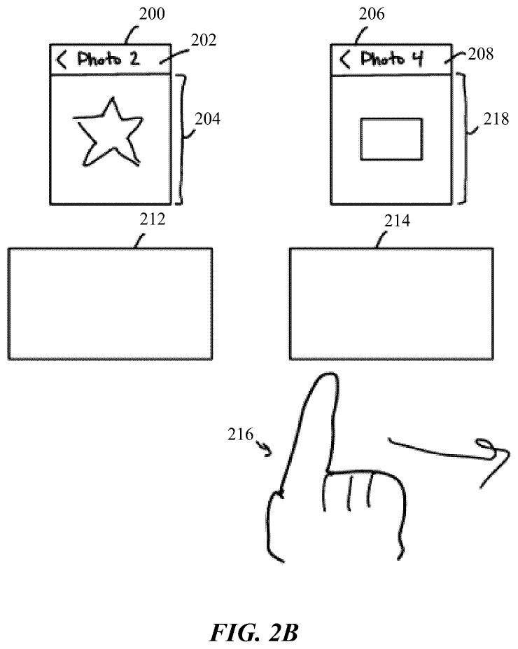

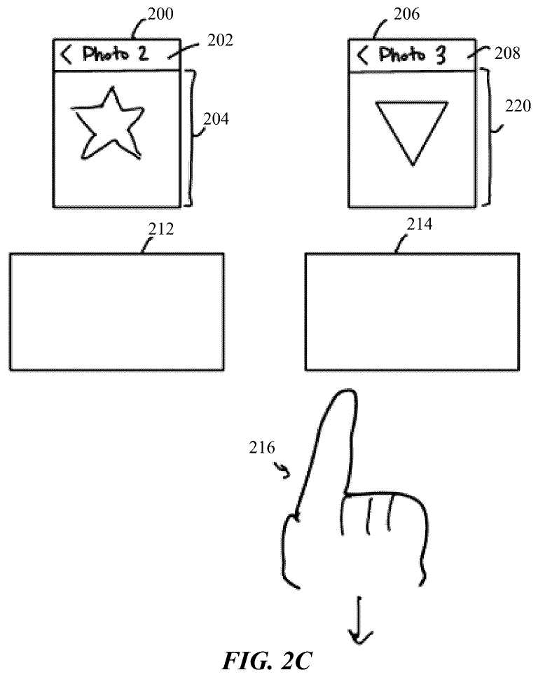

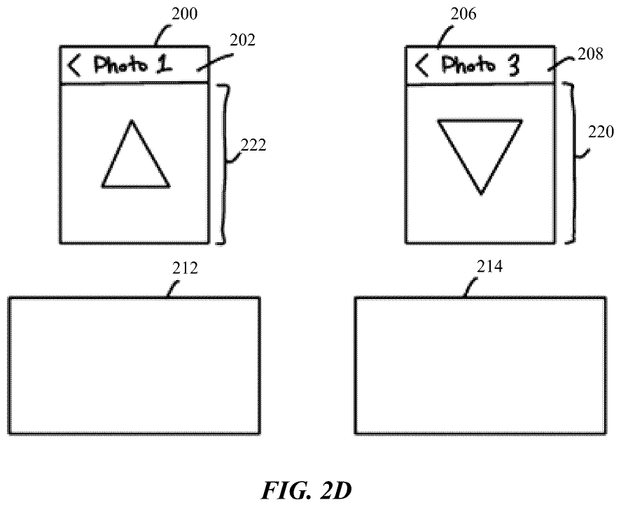

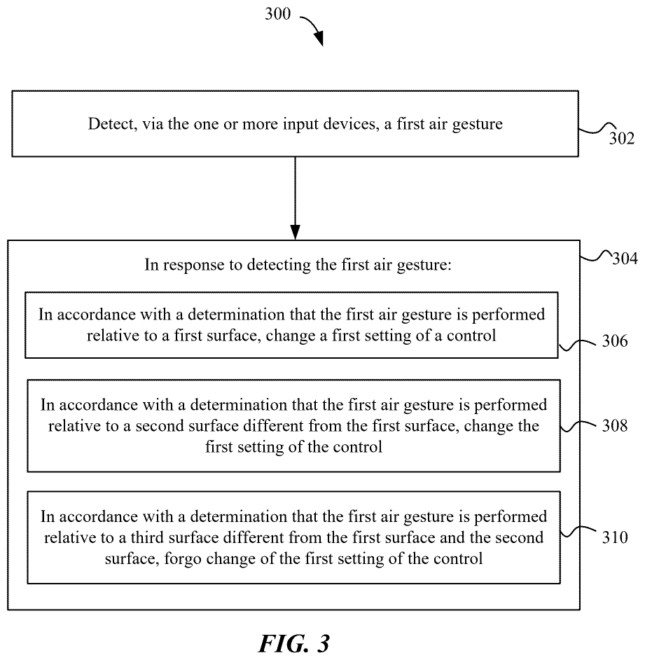

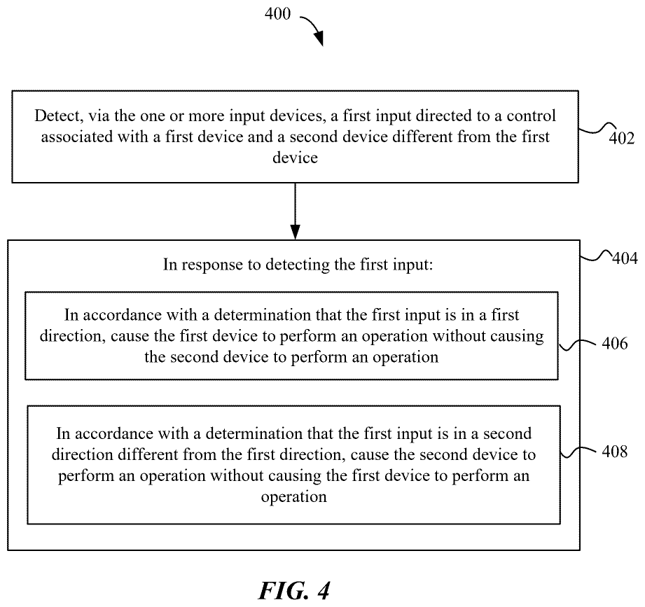

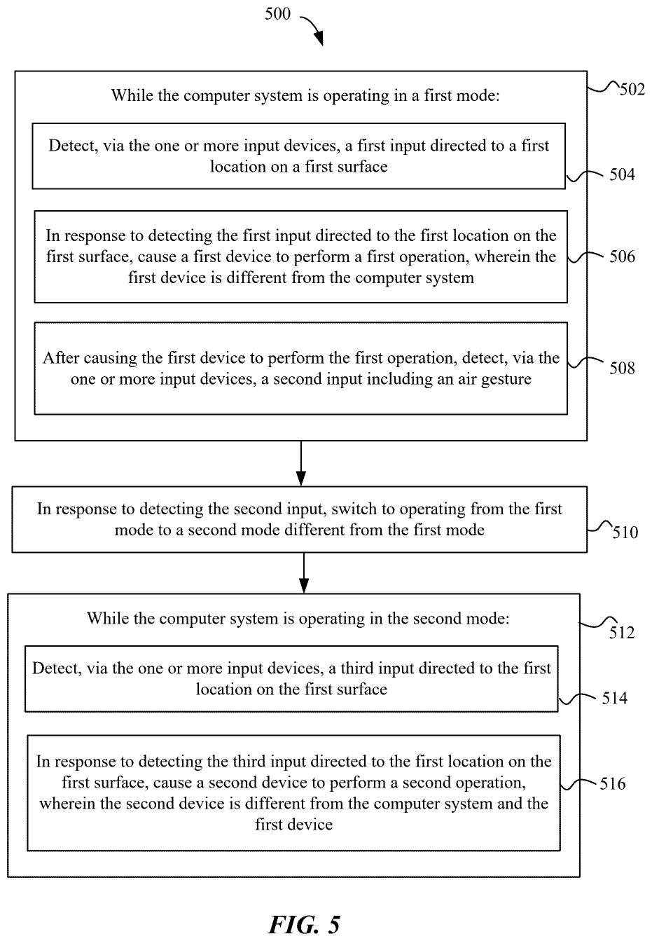

Below, FIG. 1 provides a description of an exemplary device for performing the techniques for controlling devices. FIGS. 2A-2D illustrate techniques for responding to air gestures performed relative to surfaces in accordance with some embodiments. FIG. 3 is a flow diagram illustrating a method for responding to input in accordance with some embodiments. FIG. 4 is a flow diagram illustrating a method for responding to input in accordance with some embodiments. FIG. 5 is a flow diagram illustrating a method for responding to input in accordance with some embodiments. The user interfaces in FIGS. 2A-2D are used to illustrate the processes described below, including the processes in FIGS. 3-5.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

Methods described herein can include one or more steps that are contingent upon one or more conditions being satisfied. It should be understood that a method can occur over multiple iterations of the same process with different steps of the method being satisfied in different iterations. For example, if a method requires performing a first step upon a determination that a set of one or more criteria is met and a second step upon a determination that the set of one or more criteria is not met, a person of ordinary skill in the art would appreciate that the steps of the method are repeated until both conditions, in no particular order, are satisfied. Thus, a method described with steps that are contingent upon a condition being satisfied can be rewritten as a method that is repeated until each of the conditions described in the method are satisfied. This, however, is not required of electronic device, system, or computer readable medium claims where the electronic device, system, or computer readable medium claims include instructions for performing one or more steps that are contingent upon one or more conditions being satisfied. Because the instructions for the electronic device, system, or computer readable medium claims are stored in one or more processors and/or at one or more memory locations, the electronic device, system, or computer readable medium claims include logic that can determine whether the one or more conditions have been satisfied without explicitly repeating steps of a method until all of the conditions upon which steps in the method are contingent have been satisfied. A person having ordinary skill in the art would also understand that, similar to a method with contingent steps, an electronic system, system, or computer readable storage medium can repeat the steps of a method as many times as needed to ensure that all of the contingent steps have been performed.

Although the following description uses terms “first,” “second,” etc. to describe various elements, these elements should not be limited by the terms. In some embodiments, these terms are used to distinguish one element from another. For example, a first device could be termed a second device, and, similarly, a second device or a device could be termed a first device, without departing from the scope of the various described examples. In some embodiments, the first device and the second device are two separate references to the same device. In some embodiments, the first device and the second device are both devices, but they are not the same device or the same type of device.

The terminology used in the description of the various described examples herein is for the purpose of describing particular examples only and is not intended to be limiting. As used in the description of the various described examples and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when,” “upon,” “in response to determining,” “in response to detecting,” or “in accordance with a determination that” depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” or “in accordance with a determination that [the stated condition or event]” depending on the context.

Turning to FIG. 1, a block diagram of electronic device 100 is illustrated. Electronic device 100 is a non-limiting example of an electronic device that can be used to perform functionality described herein. It should be recognized that other computer architectures of an electronic device can be used to perform functionality described herein.

In the illustrated example, electronic device 100 includes processor subsystem 110 communicating with memory 120 (e.g., a system memory) and I/O interface 130 via interconnect 150 (e.g., a system bus, one or more memory locations, or other communication channel for connecting multiple components of electronic device 100). In addition, I/O interface 130 is communicating with (e.g., wired or wirelessly) I/O device 140. In some embodiments, I/O interface 130 is included with I/O device 140 such that the two are a single component. It should be recognized that there can be one or more I/O interfaces, with each I/O interface communicating with one or more I/O devices. In some embodiments, multiple instances of processor subsystem 110 can be communicating via interconnect 150.

Electronic device 100 can be any of various types of devices, including, but not limited to, a system on a chip, a server system, a personal electronic device, a smart phone, a smart watch, a wearable device, a tablet, a laptop computer, a fitness tracking device, a head-mounted display (HMD) device, a desktop computer, an accessory (e.g., switch, light, speaker, air conditioner, heater, window cover, fan, lock, media playback device, television, and so forth), a controller, a hub, and/or a sensor. In some embodiments, a sensor includes one or more hardware components that detect information about a physical environment in proximity of (e.g., surrounding) the sensor. In some embodiments, a hardware component of a sensor includes a sensing component (e.g., an image sensor or temperature sensor), a transmitting component (e.g., a laser or radio transmitter), and/or a receiving component (e.g., a laser or radio receiver). Examples of sensors include an angle sensor, a breakage sensor such as a glass breakage sensor, a chemical sensor, a contact sensor, a non-contact sensor, a flow sensor, a force sensor, a gas sensor, a humidity or moisture sensor, an image sensor (e.g., a RGB camera and/or an infrared sensor), an inertial measurement unit, a leak sensor, a level sensor, a metal sensor, a microphone, a motion sensor, a particle sensor, a photoelectric sensor (e.g., ambient light and/or solar), a position sensor (e.g., a global positioning system), a precipitation sensor, a pressure sensor, a proximity sensor, a radiation sensor, a range or depth sensor (e.g., RADAR, LiDAR), a speed sensor, a temperature sensor, a time-of-flight sensor, a torque sensor, and an ultrasonic sensor, a vacancy sensor, an voltage and/or current sensor, and/or a water sensor. In some embodiments, sensor data is captured by fusing data from one sensor with data from one or more other sensors. Although a single electronic device is shown in FIG. 1, electronic device 100 can also be implemented as two or more electronic devices operating together.

In some embodiments, processor subsystem 110 includes one or more processors or processing units configured to execute program instructions to perform functionality described herein. For example, processor subsystem 110 can execute an operating system and/or one or more applications.

Memory 120 can include a computer readable medium (e.g., non-transitory or transitory computer readable medium) usable to store (e.g., configured to store, assigned to store, and/or that stores) program instructions executable by processor subsystem 110 to cause electronic device 100 to perform various operations described herein. For example, memory 120 can store program instructions to implement the functionality associated with method 300 described below.

Memory 120 can be implemented using different physical, non-transitory memory media, such as hard disk storage, optical drive storage, floppy disk storage, removable disk storage, removable flash drive, storage array, a storage area network (e.g., SAN), flash memory, random access memory (e.g., RAM-SRAM, EDO RAM, SDRAM, DDR SDRAM, and/or RAMBUS RAM), and/or read only memory (e.g., PROM and/or EEPROM).

I/O interface 130 can be any of various types of interfaces configured to communicate with other devices. In some embodiments, I/O interface 130 includes a bridge chip (e.g., Southbridge) from a front-side bus to one or more back-side buses. I/O interface 130 can communicate with one or more I/O devices (e.g., I/O device 140) via one or more corresponding buses or other interfaces. Examples of I/O devices include storage devices (e.g., as described above with respect to memory 120), network interface devices (e.g., to a local or wide-area network), sensor devices (e.g., as described above with respect to sensors), a physical user-interface device (e.g., a physical keyboard, a mouse, and/or a joystick), and an auditory and/or visual output device (e.g., speaker, light, screen, and/or projector). In some embodiments, the visual output device is referred to as a display generation component. The display generation component is configured to provide visual output, such as display via an LED display or image projection. As used herein, “displaying” content includes causing to display the content (e.g., video data rendered or decoded by a display controller) by transmitting, via a wired or wireless connection, data (e.g., image data or video data) to an integrated or external display generation component to visually produce the content.

In some embodiments, I/O device 140 includes one or more camera sensors (e.g., one or more optical sensors and/or one or more depth camera sensors), such as for recognizing a subject and/or a subject's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, I/O device 140 is integrated with other components of electronic device 100. In some embodiments, I/O device 140 is separate from other components of electronic device 100. In some embodiments, I/O device 140 includes a network interface device that permits electronic device 100 to communicate with a network or other electronic devices, in a wired or wireless manner. Exemplary network interface devices include Wi-Fi, Bluetooth, NFC, USB, Thunderbolt, Ethernet, Thread, UWB, and so forth.

In some embodiments, I/O device 140 include one or more camera sensors (e.g., one or more optical sensors and/or one or more depth camera sensors), such as for tracking a user's gestures (e.g., hand gestures and/or air gestures) as input. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

Attention is now directed towards techniques that are implemented on an electronic device, such as electronic device 100.

FIGS. 2A-2D illustrate techniques for responding to air gestures performed relative to surfaces in accordance with some embodiments. The user interfaces in these figures are used to illustrate the processes described below, including the processes in FIGS. 3-5.

Some techniques described herein include a subject (e.g., a person and/or a user) performing an air gesture relative to a surface (e.g., a portion of an environment, such as a top of a table or an area on a wall) to cause a computer system (e.g., an accessory device (such as a smart light, a smart speaker, a television, and/or a smart display) and/or a personal device of the subject or another subject (e.g., a smart phone, a smart watch, a tablet, a laptop, and/or a head-mounted display device)) corresponding to but different from the surface to perform an operation. In some embodiments, different air gestures performed relative to the same surface control different computer systems and/or different settings of a particular computer system. The discussion below will proceed with different surfaces already defined for different computer systems. After such discussion, techniques for configuring surfaces will be discussed.

FIGS. 2A-2D illustrate two different computer systems (e.g., first computer system 200 and second computer system 206) and two different surfaces (e.g., first surface 212 and second surface 214). As illustrated in FIGS. 2A-2D, first surface 212 is located in front of computer system 200, and second surface 214 is located in front of computer system 206. It should be recognized that such relative placements of computer systems and surfaces are used for discussion purposes and should not be considered limiting of techniques described herein.

In some embodiments, each of first computer system 200 and second computer system 206 is a smart phone that includes one or more components and/or features described above in relation to electronic device 100. In other embodiments, first computer system 200 and/or second computer system 206 can be another type of computer system, such as an accessory device, a desktop computer, a fitness tracking device, a head-mounted display device, a laptop, a smart blind, a smart display, a smart light, a smart lock, a smart speaker, a smart watch, a tablet, and/or a television. In some embodiments, first computer system 200 can be a different type of computer system than second computer system 206. For example, first computer system 200 can be a smart light while second computer system 206 can be a smart speaker, both able to respond to an air gesture to turn on or off.

In some embodiments, the two different computer systems and the two different surfaces are in a physical environment and/or a virtual environment. For example, the two different computer systems can be in a virtual environment (e.g., virtual representations corresponding to one or more features) while the two different surfaces are in a physical environment. For another example, the two different computer systems and the two different surfaces can be in a physical environment or a virtual environment. For discussion purposes below, the two different computer systems and the two different surfaces will be described in a physical environment. Examples of the physical environment include a room of a home, an office, and/or an outdoor park. It should be recognized that the physical environment can be any physical space.

While discussed below that a controller device detects air gestures and, in response, causes operations to be performed, it should be recognized that one or more computer systems can detect sensor data, communicate the sensor data, detect an air gesture using the sensor data, communicate an identification of the air gesture, determine an operation to perform in response to the air gesture, and/or cause an operation to be performed. For example, first computer system 200 can detect an air gesture via a camera of first computer system 200, determine a surface in which the air gesture was performed, and, in response, perform an operation corresponding to the air gesture when the air gesture and/or the surface corresponds to first computer system 200. For another example, an ecosystem can include a camera for capturing content (e.g., one or more images and/or a video) corresponding to an environment, a controller device for (1) detecting an air gesture in the content and (2) causing first computer system 200 or second computer system 206 to perform an operation based on detecting the air gesture. For another example, a subject can be wearing a head-mounted display device that includes a camera for capturing air gestures performed by the subject. The head-mounted display device can receive content (e.g., one or more images and/or a video) from the camera, identify an air gesture in the content, and cause first computer system 200 or second computer system 206 to perform an operation based on the air gesture. For another example, a subject can be wearing a smart watch that includes a gyroscope for capturing air gestures performed by the subject. The smart watch can receive sensor data from the gyroscope, identify an air gesture using the sensor data, send an identification of the air gesture to another computer system (e.g., a smart phone) so that the smart phone can cause first computer system 200 or second computer system 206 to perform an operation based on the air gesture.

In some embodiments, the controller device includes first surface 212 and/or second surface 214. In some embodiments, first computer system 200 includes first surface 212 and/or second surface 214. In some embodiments, second computer system 206 includes first surface 212 and/or second surface 214. In some embodiments, another computer system different from the controller device, first computer system 200, and second computer system 206 includes first surface 212 and/or second surface 214. In some embodiments, first surface 212 and/or second surface 214 are not part of and/or included in a computer system.

In some embodiments, first surface 212 and/or second surface 214 is not a touch-sensitive surface and/or physical input mechanism (e.g., a physical button or slider). For example, first surface 212 and/or second surface 214 might not detect inputs (e.g., air gestures) described herein. Instead, a camera can capture an image of an input (e.g., an air gesture) performed relative to first surface 212 and/or second surface 214. In some embodiments, first surface 212 and/or second surface 214 includes one or more visual elements that are used as a visual guide of a subject when interacting with first surface 212 and/or second surface 214. For example, first surface 212 and/or second surface 214 can include a horizontal line and a vertical line to indicate that horizontal and vertical air gestures can be used relative to first surface 212 and/or second surface 214 to perform an operation. In some embodiments, first surface 212 and/or second surface 214 is a touch-sensitive surface and/or physical input mechanism. In such embodiments, first surface 212 and/or second surface 214 can detect an input and send an identification of the input to the controller device and/or to first computer system 200 and/or second computer system 206 (e.g., when first surface 212 and/or second surface 214 is aware of a connection between one or more types of inputs and first computer system 200 and/or second computer system 206).

As illustrated in FIG. 2A, first computer system 200 displays photo user interface 202, which includes image 204 of a star titled “Photo 2.” In some embodiments, photo user interface 202 is a user interface of a photo application executing on first computer system 200. The photo application can allow a subject to view different photos via photo user interface 202. It should be recognized that photo user interface 202 is just one example of a user interface used with techniques described herein and that other user interfaces (e.g., a home user interface (e.g., to view a status of and/or control one or more accessories) or a music user interface (e.g., to search for and/or play one or more songs)) can use techniques described herein. In addition, it should be recognized that techniques described here can be used without a user interface being displayed, such as when controlling a brightness level of a lamp or height of a smart blind.

As illustrated in FIG. 2A, second computer system 206 displays photo user interface 208, which includes image 210 of a circle titled “Photo 5.” Consistent with the description above, photo user interface 208 can be a user interface for a photo application executing on second computer system 206, and photo user interface 208 is just one example of a user interface used with techniques described herein. In some embodiments, first computer system 200 and second computer system 206 display different user interfaces using techniques described herein.

FIG. 2A illustrates hand 216 of a subject (e.g., a person and/or a user of first computer system 200 and/or second computer system 206). In some embodiments, the subject is in the physical environment including first surface 212 and second surface 214. Examples of first surface 212 and/or second surface 214 include the top of a table, the left side of a desk, and/or an area on a wall.

In some embodiments, different surfaces are defined to correspond to different computer systems for performing particular operations. At FIG. 2A, first surface 212 is defined to correspond to second computer system 208 when swipe gestures in a left or right direction are performed relative to first surface 212, causing an image to change as discussed further below. At FIG. 2A, second surface 214 is defined to correspond to (1) first computer system 200 for swipe gestures performed in an upward or downward direction, causing an image to change as discussed further below, and (2) second computer system 200 for swipe gestures performed in a left or right direction, causing an image to change as discussed further below. In some embodiments, second surface 214 is defined to correspond to both first computer system 200 and second computer system 206 for swipe gestures performed in a right diagonal direction, such that an operation is performed with respect to both first computer system 200 and second computer system 206 when a swipe gesture is detected in the right diagonal direction relative to second surface 214. In some embodiments, second surface 214 is defined to not correspond to a computer system for swipe gestures performed in a left diagonal direction, such that no operation or an operation with respect to the controller device is performed when a swipe gesture is detected in the left diagonal direction. In some embodiments, another surface other than first surface 212 and second surface 214 is defined to not correspond to a computer system (e.g., first computer system 200, second computer system 206, and/or another computer system different from first computer system 200 and second computer system 206), such that no operation is performed when an air gesture is detected relative to the other surface. In some embodiments, when other types of air gestures not described above (and/or not defined for a surface) are performed relative to first surface 212 and/or second surface 214, no operation is performed. It should also be recognized that such correspondence and operations are just examples and that other air gestures and/or correspondence can be used with techniques described herein.

As illustrated in FIG. 2A, hand 216 has a single finger extended and is performing a first type of air gesture (e.g., a swipe gesture, as further discussed below) in the right direction at a position (e.g., location and/or orientation) relative to (e.g., determined to touch and/or within a predefined distance and/or direction of) first surface 212. In some embodiments, the single finger touches surface 212 at a first location and is dragged across surface 212 to the right to another location of surface 212. In other embodiments, the single finger does not touch surface 212 but rather approaches surface 212 without touching surface 212 and performs a movement in the air from a first position to another position to the right of the first location. It should be recognized that the swipe gesture can include a different movement and/or position than explicitly described in this paragraph. At FIG. 2A, the controller device detects the swipe gesture in the right direction at a position relative to first surface 212.

As illustrated in FIG. 2B, in response to detecting the swipe gesture in the right direction at a position relative to first surface 212, the controller device causes second computer system 206 to (1) cease displaying image 210 and (2) display image 218 in photo user interface 208. In some embodiments, image 218 includes a rectangle and is titled “Photo 4.” In some embodiments, image 218 is a previous image of the photo application (e.g., of second computer system 206) relative to image 210. It should be recognized that changing images is just one example of an operation performed in response to the swipe gesture in FIG. 2A and that one or more other operations can be performed in addition to and/or instead of changing images. In some embodiments, different operations are performed in response to the swipe gesture depending on which user interface is being displayed by a computer system being affected. For example, if second computer system 206 is displaying a user interface different from photo user interface 208, second computer system 206 can perform a different operation than displaying a previous image in response to detecting the swipe gesture in the right direction (e.g., as illustrated in FIG. 2B).

At FIG. 2B, in response to detecting the swipe gesture in the right direction at a position relative to first surface 212, the controller device does not cause first computer system 200 to perform an operation. Instead, first computer system 200 maintains display of photo user interface 202 with image 204. In some embodiments, the swipe gesture in the right direction (e.g., as illustrated in FIG. 2A) does not affect first computer system 200 (e.g., as a result of the controller device detecting that the swipe gesture in the right direction is (1) relative to a surface not defined for first computer system 200 and/or (2) an air gesture that is not defined for first computer system 200 with first surface 212 (e.g., other air gestures and/or types of air gestures might be defined for first computer system 200 with first surface 212, including a swipe gesture in a different direction and/or another type of gesture such as a pinch gesture)).

As illustrated in FIG. 2B, hand 216 performs the first type of air gesture (e.g., a swipe gesture) in the right direction at a position relative to (e.g., determined to touch and/or within a predefined distance and/or direction of) second surface 214. Notably, the swipe gesture performed in FIG. 2B is the same air gesture as performed in FIG. 2A except relative to a different surface (e.g., the swipe gesture at FIG. 2B is relative to second surface 214 while the swipe gesture at FIG. 2A is relative to first surface 212).

As illustrated in FIG. 2C, in response to detecting the swipe gesture in the right direction at a position relative to second surface 214, the controller device causes second computer system 206 to (1) cease displaying image 218 and (2) display image 220 in photo user interface 208. In some embodiments, image 220 includes an upside-down triangle and is titled “Photo 3.” In some embodiments, image 220 is a previous image of the photo application (e.g., of second computer system 206) relative to image 218. Consistent with above, it should be recognized that changing images is just one example of an operation performed in response to the swipe gesture in FIG. 2B and that one or more other operations can be performed in addition to and/or instead of changing images.

At FIG. 2C, in response to detecting the swipe gesture in the right direction at a position relative to second surface 214, the controller device does not cause first computer system 200 to perform an operation. Instead, first computer system 200 maintains display of photo user interface 202 with image 204. In some embodiments, the swipe gesture in the right direction (e.g., as illustrated in FIG. 2B) does not affect first computer system 200 (e.g., as a result of the controller device detecting that the swipe gesture in the right direction is an air gesture that is not defined for first computer system 200 with second surface 214 (e.g., other air gestures and/or types of air gestures might be defined for first computer system 200 with second surface 212, including swipe gestures in the upward or downward direction)).

As illustrated in FIG. 2C, hand 216 performs the first type of air gesture (e.g., a swipe gesture) in a downward direction at a position relative to (e.g., determined to touch and/or within a predefined distance and/or direction of) second surface 214. Notably, the swipe gesture performed in FIG. 2C is a different air gesture than performed in FIGS. 2A-2B (e.g., the swipe gesture at FIG. 2C is in the downward direction while the swipe gestures at FIGS. 2A-2B are in the right direction) but relative to the same surface as the swipe gesture in FIG. 2B (e.g., second surface 214).

As illustrated in FIG. 2D, in response to detecting the swipe gesture in the downward direction at a position relative to second surface 214, the controller device causes first computer system 200 to (1) cease displaying image 204 and (2) display image 222 in photo user interface 202. In some embodiments, image 222 includes a triangle and is titled “Photo 1.” In some embodiments, image 222 is a previous image of the photo application (e.g., of first computer system 200) relative to image 204. Consistent with above, it should be recognized that changing images is just one example of an operation performed in response to the swipe gesture in FIG. 2C and that one or more other operations can be performed in addition to and/or instead of changing images.

At FIG. 2D, in response to detecting the swipe gesture in the downward direction at a position relative to second surface 214, the controller device does not cause second computer system 206 to perform an operation. Instead, second computer system 206 maintains display of photo user interface 208 with image 220. In some embodiments, the swipe gesture in the downward direction (e.g., as illustrated in FIG. 2C) does not affect second computer system 206 (e.g., as a result of the controller device detecting that the swipe gesture in the downward direction is an air gesture that is not defined for first computer system 200 with second surface 214 (e.g., other air gestures and/or types of air gestures might be defined for first computer system 200 with second surface 214)).

While the above discussion of FIGS. 2A-2D is with respect to performing different operations with different air gestures, it should be recognized that, in some embodiments, different air gestures and/or types of air gestures can change (1) a single control in different ways (e.g., increase or decrease a brightness of a light), (2) a computer system in different ways (e.g., increase volume or current channel of a television), (3) the same characteristic or feature on different computer systems (e.g., change a color of a first light or change a color of a second light), and/or (4) different features or characteristics of different computer systems (e.g., turn down volume of a speaker or turn off an air conditioning unit).

While the above discussion of FIGS. 2A-2D is with respect to a single subject (e.g., a subject with hand 216), it should be recognized that, in some embodiments, different subjects can have different surfaces configured for the same or different operations. For example, one subject can have a configuration that allows air gestures relative to first surface 212 to change images of photo user interface 202 and another subject can have a configuration that allows air gestures relative to first surface 212 to change a brightness level of first computer system 200. It should also be recognized that, in some embodiments, different subjects can have the same surface configured for the same or different operations. For example, one subject can have a configuration that allows swipe gestures in a diagonal direction relative to second surface 214 to change which image is displayed in photo user interface 208 and another subject can have a configuration that allows swipe gestures in the left or right direction relative to second surface 214 change which image is displayed in photo user interface 208.

Attention is now directed towards configuring a surface to be used with techniques described herein. For example, before using techniques described above, a surface can be configured to cause an operation to be performed when an air gesture is detected relative to the surface. In such embodiments, the surface, the operation, and/or the air gesture can be automatically selected by a computer system (e.g., the controller device or another computer system different from the controller device) or manually selected via input from a user.

As mentioned above, in some embodiments, the controller device can automatically select a surface for controlling a computer system. In such embodiments, the controller device can already have identified (e.g., automatically and/or manually, as described below) a particular operation and/or a particular air gesture (e.g., to cause the particular operation to be performed). For example, the controller device can automatically select a surface that is nearby a subject and/or nearby the computer system (e.g., without requiring a subject to indicate to use the surface). In some embodiments, the surface is automatically selected when the surface meets a set of one or more selection criteria, such as including one or more markings (e.g., a horizontal line and/or a vertical line, as described above) and/or being a particular size, orientation, and/or amount of accessibility (e.g., with respect to the subject). However, it should be recognized that other criteria can be used to automatically select a surface.

In some embodiments, the controller device automatically selects an air gesture for controlling a computer system. In such embodiments, the controller device can already have identified (e.g., automatically and/or manually, as described above and below) a particular surface and/or a particular operation (e.g., to be performed by the air gesture that is selected). In some embodiments, the air gesture is selected based on a predefined correspondence between an operation and an air gesture. In such embodiments, the predefined correspondence can be a result of a process, such as a machine learning algorithm (e.g., trained on previous interactions with the controller device and/or one or more other devices), that identifies common air gestures for common operations. For example, a first operation to increase a value can be defined to correspond to a swipe gesture in an upward direction (e.g., swipe gestures in an upward direction are by default used to increase values). Accordingly, when the first operation is already selected, the controller device can automatically select a swipe gesture in an upward direction as the air gesture for causing the first operation (e.g., without requiring a subject to indicate to use the swipe gesture in the upward direction). However, it should be recognized that other criteria can be used to automatically select an air gesture for a surface.

In some embodiments, the controller device automatically selects an operation to correspond to a particular surface. In such embodiments, the controller can already have identified (e.g., automatically and/or manually, as described above and below) a particular surface and/or a particular air gesture (e.g., to be performed relative to the particular surface). For example, the controller device can have identified that a pinch gesture is going to be configured to be used near a particular area on a wall; however, the controller device has not identified what operation to perform when the pinch gesture is detected near the particular area on the wall. The controller device can identify (e.g., either automatically or manually) an application and/or a computer system to be used for the pinch gesture. The controller device can then automatically identify operations that are able to be used for the application and/or the computer system. After identifying the operations, the controller device can automatically identify a particular operation of the operations to be used with the pinch gesture near the particular area on the wall. Such identification can be performed using a process, such as a machine learning algorithm (e.g., trained on previous interactions with the controller device and/or one or more other devices), that identifies common operations for the pinch gesture, the application, and/or the computer system. However, it should be recognized that other criteria can be used to automatically select an operation to configure for a surface.

In some embodiments, a subject can manually select a surface, an air gesture, and an operation to be used with techniques described herein. For example, the controller device can detect input from the subject that includes an identification of the surface, the air gesture, and/or the operation (e.g., an audio input that says “I want to confirm the top of this table as a control for turning off the lights in this room”). Based on the input, the controller device can configure the surface to be used with techniques described herein for performing the air gesture to cause the operation to be performed, as discussed above with respect to FIGS. 2A-2D and discussed further below.

In some embodiments, while in a configuration mode, a subject can identify a surface, an air gesture, and/or an operation. In response to the subject identifying the surface, the air gesture, and/or the operation, the controller device can associate the operation to be performed when detecting the air gesture relative to the surface while in an operating mode.

In some embodiments, the subject identifies the surface by pointing and/or otherwise performing an air gesture to identify an area corresponding to the surface. In some embodiments, the subject identifies the surface by speaking a description of the surface to the controller device. In some embodiments, the subject identifies the surface by drawing an area within a live preview of an environment. It should be recognized that such embodiments for identifying the surface are just examples and that other ways can be used to identify a surface.

In some embodiments, the subject identifies a computer system to be controlled via an air gesture by pointing and/or otherwise performing an air gesture in a direction towards the computer system. In some embodiments, the subject identifies the computer system by speaking a description of the computer system to the controller device. In some embodiments, the subject identifies the computer system by touching the computer system and/or providing a touch input in a live preview of an environment at a location corresponding to the computer system. It should be recognized that such embodiments for identifying the computer system are just examples and that other ways can be used to identify a computer system.

In some embodiments, the subject identifies (1) a computer system to be controlled via an air gesture and (2) a surface for which the air gesture can be performed relative to. For example, the subject can touch the computer system and then touch a particular surface to configure the controller device to control the computer system when an air gesture is performed relative to the particular surface.

In some embodiments, the subject identifies the air gesture for a particular operation by performing an example and/or demonstration of the air gesture and/or verbally describing the air gesture. The example and/or demonstration of the air gesture can be performed relative to a surface or not. In some embodiments, when performed relative to a surface before identifying a surface, performing the demonstration of the air gesture both identifies a surface and an air gesture at the same time.

In some embodiments, the subject identifies the operation by navigating in a user interface to a particular operation before identifying a surface and/or an air gesture. For example, a subject can open an application and navigate to a user interface for configuring a surface. In some embodiments, the subject identifies the operation by selecting the operation in a list of operations and/or by verbally describing the operation. In some embodiments, specific operations may be pre-defined or may be defined by the subject (e.g., in the application).

While the above discussion of configuring a surface is primarily described as identifying operations before interacting with surfaces, it should be recognized that, in some embodiments, such operations can be identified after interacting with surfaces such as to re-configure surfaces. For example, a first air gesture (e.g., a swipe gesture to the right) performed relative to a first surface (e.g., a table top) can be configured to cause a first operation (e.g., change a color of a light) to be performed. In some embodiments, the first air gesture can be changed such that a different air gesture (e.g., an upward swipe gesture) performed relative to the first surface (e.g., the table top) is configured to cause the first operation (e.g., change a color of the light) to be performed. In some embodiments, the first surface can be changed such that the first air gesture performed relative to a different surface (e.g., a night stand instead of the table top) is configured to cause the first operation (e.g., change a color of the light) to be performed. In some embodiments, the first operation (e.g., change a color of the light) can be changed such that the first air gesture (e.g., a swipe gesture to the right) performed relative to the first surface (e.g., the table top) is configured to cause a different operation (e.g., turn the light on or off) to be performed.

In some embodiments, when a first air gesture (e.g., a swipe gesture to the right) is changed to a second air gesture (e.g., an upward swipe gesture) for performing a first operation (e.g., change a color of the light) when performed relative to a surface (e.g., the table top), the first air gesture can be configured to no longer work with respect to the surface. For example, after changing to the second air gesture, detecting the first air gesture will no longer change a color of the light when performed relative to the table top, but detecting the second air gesture will change a color of the light when performed relative to the table top.

In some embodiments, when a first air gesture (e.g., a swipe gesture to the right) is changed to a second air gesture (e.g., an upward swipe gesture) for performing a first operation (e.g., change a color of the light) when performed relative to a surface (e.g., the table top), the first air gesture can be configured to still work with respect to the surface. For example, after changing to the second air gesture, detecting either the first air gesture or the second air gesture will change a color of the light when performed relative to the table top.

In some embodiments, when a first surface (e.g., an area of a wall) is changed to a second surface (e.g., a side of a chair) for performing an operation (e.g., turning the temperature up on an air conditioner) when an air gesture (e.g., an upward swipe gesture) is detected, the first surface can be configured to no longer work with respect to the air gesture and the operation. For example, after changing the first surface to the second surface, detecting the upward swipe gesture relative to the first surface will not turn the temperature up on the air conditioner, but detecting the upward swipe gesture relative to the second surface will turn the temperature up on the air conditioner.

In some embodiments, when a first surface (e.g., an area of a wall) is changed to a second surface (e.g., a side of a chair) for performing an operation (e.g., turning the temperature up on an air conditioner) when an air gesture (e.g., an upward swipe gesture) is detected, the first surface can be configured to still work with respect to the air gesture and the operation. For example, after changing the first surface to the second surface, detecting the upward swipe gesture relative to either the first surface or the second surface will turn the temperature up on the air conditioner.

In some embodiments, when a first operation (e.g., turning on a light) is changed to a second operation (e.g., turning on a television) when a particular air gesture is performed relative to a particular surface, the first operation can be configured to no longer work when the particular air gesture is performed relative to the particular surface. For example, after changing the first operation to the second operation, detecting the particular air gesture relative to the particular surface will not turn on the light but rather turn on the television.

In some embodiments, when a first operation is changed to a second operation when a particular air gesture is performed relative to a particular surface, the first operation can be configured to still work when the particular air gesture is performed relative to the particular surface. For example, after changing the first operation to the second operation, detecting the particular air gesture relative to the particular surface will turn on both the light and the television.

As mentioned above, the controller device can operate in the configuration mode or the operating mode. In some embodiments, the operating mode can allow for different inputs (e.g., an air gesture, an input detected via a touch-sensitive surface, an input of a physical input mechanism (such as a hardware button or slider), and/or a verbal input detected via a microphone) to change a set of surfaces, air gestures, and/or operations that are configured for an environment (different sets of surfaces, air gestures, and/or operations are sometimes referred to as different modes herein). For example, the controller device, when detecting a wave air gesture, can be configured to change from a first set of surfaces, air gestures, and/or operations (sometimes referred to as a first mode) to a second set of surfaces, air gestures, and/or operations (sometimes referred to as a second mode). This aspect of the controller device allows for a subject to quickly change configuration of the environment without requiring individual changes and/or configuration of each surface, each air gesture, and/or each operation at a given time when the switch should occur. For example, before detecting the wave air gesture, a subject can perform a tap air gesture relative to a wall surface to perform an operation on a tablet. After detecting the wave air gesture, the subject can perform a tap air gesture relative to a desk surface to perform the operation on the tablet. In an example, after detecting the wave air gesture, a tap air gesture performed relative to the wall surface can perform an operation on a television instead of the operation on the tablet.

In some embodiments, different inputs cause different sets of surfaces, air gestures, and/or operations to be configured for the environment. For example, a first set can include a first air gesture for a first operation when detected relative to a first surface, a second set can include a second air gesture for a second operation when detected relative to a second surface, and a third set can include a third air gesture performed relative to a third surface. In such an example, while the first set is configured to be active, the second set and the third set are not active (e.g., while the first set is configured to be active, detecting the second air gesture relative to the second surface would not cause the second operation to be performed and detecting the third air gesture relative to the third surface would not cause the third operation to be performed but detecting the first air gesture relative to the first surface would cause the first operation to be performed). In such an example, detecting a left wave air gesture while the first set is configured to be active can cause the second set to be active while the first set and the third set are not active (e.g., while the second set is configured to be active, detecting the first air gesture relative to the first surface would not cause the first operation to be performed and detecting the third air gesture relative to the third surface would not cause the third operation to be performed but detecting the second air gesture relative to the second surface would cause the second operation to be performed). In such an example, detecting a right wave air gesture while the first set is configured to be active can cause the third set to be active while the first set and the second set are not active (e.g., while the third set is configured to be active, detecting the first air gesture relative to the first surface would not cause the first operation to be performed and detecting the second air gesture relative to the second surface would not cause the second operation to be performed but detecting the third air gesture relative to the third surface would cause the third operation to be performed).

FIG. 3 is a flow diagram illustrating a method (e.g., method 300) for responding to input in accordance with some embodiments. Some operations in method 300 are, optionally, combined, the orders of some operations are, optionally, changed, and some operations are, optionally, omitted.

As described below, method 300 provides an intuitive way for responding to input. Method 300 reduces the cognitive burden on a user for interacting with computer systems, thereby creating a more efficient human-machine interface. For battery-operated computing devices, enabling a user to interact with computer systems faster and more efficiently conserves power and increases the time between battery charges.

In some embodiments, method 300 is performed at a first computer system (e.g., the controller device, as described herein) that is in communication with one or more input devices (e.g., a camera, a depth sensor, and/or a microphone). In some embodiments, the computer system is an accessory, a controller, a fitness tracking device, a watch, a phone, a tablet, a processor, a head-mounted display (HMD) device, and/or a personal computing device. In some embodiments, the computer system includes the one or more input devices.

The first computer system detects (302), via the one or more input devices, a first air gesture (e.g., a hand input to pick up, a hand input to press, an air tap, an air swipe, and/or a clench and hold air input) (e.g., as discussed with respect to hand 216 in FIGS. 2A, 2B, and/or 2C).

In response to (304) detecting the first air gesture, in accordance with a determination that the first air gesture is performed relative to (and/or in proximity with) (and/or near, corresponds to, is associated with, and/or directed to) a first surface (e.g., 212 and/or 214) (e.g., an outside, an exterior, a side, an outward portion, and/or at least a portion of an object), the first computer system changes (306) (and/or modifies, updates, and/or causes changing of) a first setting (e.g., as described above with respect to FIGS. 2B, 2C, and/or 2D, such as a volume level, a brightness level, and/or what image is displayed) (e.g., a current state and/or an adjustment in a software program or hardware device that changes (e.g., based on a user's preference)) (e.g., a volume, a brightness, and/or a color) of a control (e.g., as described above with respect to FIGS. 2B, 2C, and/or 2D, such as a volume control, a brightness control, and/or a display) (e.g., a user element, a slide, a button, a knob, and/or component configured to provide functionality). In some embodiments, the surface is part of a computer system and/or a device including the control. In some embodiments, the surface is separate and/or different from a computer system and/or a device including the control. In some embodiments, the first surface includes an input device. In some embodiments, the first surface does not include an input device. In some embodiments, an input device of the first surface detects the first air gesture. In some embodiments, the one or more input devices are separate and/or different from the surface. In some embodiments, the control is another computer system different from the computer system.

In response to (304) detecting the first air gesture, in accordance with a determination that the first air gesture is performed relative to (and/or in proximity with) (and/or near, corresponds to, is associated with, and/or directed to) a second surface (e.g., 212 and/or 214) different from the first surface (e.g., and/or not relative to the first surface), the first computer system changes (308) (and/or modifies, updates, and/or causes changing of) the first setting of the control.

In response to (304) detecting the first air gesture, in accordance with a determination that the first air gesture is performed relative to (and/or in proximity with) (and/or near, corresponds to, is associated with, and/or directed to) a third surface (e.g., 212, 214, and/or another surface as discussed above with respect to FIGS. 2A-2D) different from the first surface and the second surface, the first computer system forgoes (310) change of the first setting of the control. Changing the first setting of the control based on the determination that the first air gesture is performed relative to the first surface and the second surface and not performed relative to the third surface enables the first computer system to utilize different surfaces differently for changing settings of controls, thereby performing an operation when a set of conditions has been met without requiring further user input, providing additional control options without cluttering the user interface with additional displayed controls, and/or providing improved feedback to the user.

In some embodiments, after detecting the first air gesture, the first computer system detects, via the one or more input devices, a second air gesture (e.g., as discussed with respect to hand 216 in FIGS. 2B and/or 2C) separate from the first air gesture (e.g., the same as the first air gesture and/or different from the first air gesture). In some embodiments, in response to detecting the second air gesture, in accordance with a determination that the second air gesture is performed relative to a fourth surface (e.g., 212 and/or 214) and that a first subject (e.g., the subject corresponding to hand 212 and/or another subject as discussed above with respect to FIGS. 2A-2D) performed the second air gesture, the first computer system performs a first operation (e.g., changing what image is displayed, as discussed above with respect to FIGS. 2A-2D). In some embodiments, in response to detecting the second air gesture, in accordance with a determination that the second air gesture is performed relative to the fourth surface and that a second subject (e.g., the subject corresponding to hand 212 and/or another subject as discussed above with respect to FIGS. 2A-2D) different from the first subject performed the second air gesture, the first computer system performs a second operation (e.g., changing what image is displayed, as discussed above with respect to FIGS. 2A-2D) different from the first operation. In some embodiments, the fourth surface is different from the first surface, the second surface, and/or the third surface. Performing different operations when the second air gesture is performed relative to the fourth surface and based on which subject performed the second air gesture enables the first computer system to automatically perform operations based on the user that performed the gesture and the surface that gesture is performed relative to, thereby performing an operation when a set of conditions has been met without requiring further user input, providing additional control options without cluttering the user interface with additional displayed controls, and/or providing improved feedback to the user.

In some embodiments, performing the first air gesture relative to the first surface includes performing the first air gesture within a first predefined distance (e.g., as discussed above with respect to FIG. 2A) from the first surface. In some embodiments, performing the first air gesture relative to the second surface includes performing the first air gesture within a second predefined distance (e.g., as discussed above with respect to FIG. 2A) from the second surface. In some embodiments, the second predefined distance is the same as or different from the first predefined distance. In some embodiments, performing the first air gesture relative to the third surface includes performing the first air gesture within a third predefined distance (e.g., as discussed above with respect to FIG. 2A) from the third surface. In some embodiments, the third predefined distance is the same as or different from the first predefined distance and/or the second predefined distance. Changing the first setting of a control based on the determination that the first air gesture is performed within a predefined distance from the first surface, the second surface, and the third surface enables the first computer system to determine which surface that the first air gesture is performed using distance from a surface rather than requiring the surface to be touch sensitive, thereby performing an operation when a set of conditions has been met without requiring further user input, providing additional control options without cluttering the user interface with additional displayed controls, and/or providing improved feedback to the user.

In some embodiments, the first surface is separate from (and/or is not a part of, is not integrated with, and/or does not correspond to) the first computer system. In some embodiments, the second surface is separate from (and/or is not a part of, is not integrated with, and/or does not correspond to) the first computer system. In some embodiments, the third surface is separate from (and/or is not a part of, is not integrated with, and/or does not correspond to) the first computer system. The first surface, the second surface, and the third surface being separate from the first computer system enables the first computer system to detect inputs relative to surfaces separate from the first computer system to perform operations (e.g., in some embodiments, the possibility of surfaces separate from the first computer system are greater than the possibility of surfaces of the first computer system, thereby providing additional control options without cluttering the user interface with additional displayed controls, and/or providing improved feedback to the user.

In some embodiments, the first computer system includes the first surface, the second surface, or the third surface (e.g., the first surface, the second surface, and/or the third surface is a part of and/or integrated with the first computer system) (e.g., the first surface is of the first computer system) (e.g., the second surface is of the first computer system) (e.g., the third surface is of the first computer system). In some embodiments, the first computer system includes the first surface, the second surface, and/or the third surface.

In some embodiments, the first setting of the control corresponds to a second computer system (e.g., 200 and/or 206) different from the first computer system. In some embodiments, the second computer system includes the first surface, the second surface, or the third surface (e.g., the first surface, the second surface, and/or the third surface is a part of and/or integrated with the second computer system) (e.g., the first surface is of the second computer system) (e.g., the second surface is of the second computer system) (e.g., the third surface is of the second computer system). In some embodiments, the second computer system includes the first surface, the second surface, and/or the third surface.

In some embodiments, the control corresponds to the first computer system (e.g., without corresponding to another computer system different from the first computer system). In some embodiments, the control is a control of the first computer system. In some embodiments, the control corresponds to a setting of the first computer system. In some embodiments, the control corresponds to a function and/or functionality of the first computer system.

In some embodiments, the control corresponds to a third computer system (e.g., 200 and/or 206) different from the first computer system (e.g., without corresponding to the first computer system). In some embodiments, the control is a control of the third computer system. In some embodiments, the control corresponds to a setting of the third computer system. In some embodiments, the control corresponds to a function and/or functionality of the third computer system. In some embodiments, changing the first setting of the control includes sending a request and/or command to the third computer system.

In some embodiments, after detecting the first air gesture, the first computer system detects, via the one or more input devices, a third air gesture (e.g., as discussed with respect to hand 216 in FIGS. 2A, 2B, and/or 2C) different from (e.g., different type and/or separate from) the first air gesture. In some embodiments, in response to detecting the third air gesture and in accordance with a determination that the third air gesture is performed relative to the first surface, the first computer system changes a second setting (e.g., as discussed with respect to FIGS. 2A-2C) of the control, wherein the second setting is different from the first setting. In some embodiments, in accordance with a determination that the third air gesture is performed relative to the second surface, the first computer system changes the second setting of the control. In some embodiments, in accordance with a determination that the third air gesture is performed relative to the second surface, the first computer system does not change the second setting of the control. In some embodiments, in accordance with a determination that the third air gesture is performed relative to the third surface, the first computer system forgoes changing the second setting of the control. Changing the second setting of the control in response to detecting the third air gesture enables the first computer system to change different settings with different air gestures after changing the first setting, thereby performing an operation when a set of conditions has been met without requiring further user input, providing additional control options without cluttering the user interface with additional displayed controls, and/or providing improved feedback to the user.

In some embodiments, the third air gesture is a different type of air gesture (e.g., a selection air gesture, a movement air gesture, a non-movement air gesture, a undo air gesture, a redo air gesture, a pinch air gesture, an air gesture in a different direction, and/or a separate air gesture) than the first air gesture (e.g., the third air gesture is a particular type of air gesture and the first air gesture is another type of air gesture different from the particular type of air gesture). Different types of air gestures relative to the same surface causing different settings to be changed enables a user to have more control with air gestures relative to a particular surface, allowing different settings to be changed by changing the type of air gesture used, thereby performing an operation when a set of conditions has been met without requiring further user input, providing additional control options without cluttering the user interface with additional displayed controls, and/or providing improved feedback to the user.

In some embodiments, after detecting the first air gesture, the first computer system detects, via the one or more input devices, a fourth air gesture (e.g., as discussed with respect to hand 216 in FIGS. 2A, 2B, and/or 2C) different from the first air gesture. In some embodiments, in response to detecting the fourth air gesture, in accordance with a determination that the fourth air gesture is in a first direction (e.g., left or right, as discussed with respect to hand 216 in FIGS. 2A-2B), the first computer system changes a third setting (e.g., an image of photo user interface 208, as discussed above with respect to FIGS. 2B-2C). In some embodiments, the third setting is different from the first setting. In some embodiments, the third setting is the same as the first setting. In some embodiments, in response to detecting the fourth air gesture, in accordance with a determination that the fourth air gesture is a second direction (e.g., up or down, as discussed with respect to hand 216 in FIGS. 2A-2B) different from the first direction, the first computer system changes a fourth setting (e.g., an image of photo user interface 202, as discussed above with respect to FIG. 2D) different from the third setting. In some embodiments, the fourth setting is different from the first setting. In some embodiments, the fourth setting is the same as the third setting. Changing different settings based on a direction of an air gesture enables a user to have more control with air gestures relative to a particular surface, allowing different settings to be changed by changing the direction of the air gesture, thereby performing an operation when a set of conditions has been met without requiring further user input, providing additional control options without cluttering the user interface with additional displayed controls, and/or providing improved feedback to the user.

In some embodiments, after detecting the first air gesture, the first computer system detects, via the one or more input devices, a fifth air gesture (e.g., as discussed with respect to hand 216 in FIGS. 2A, 2B, and/or 2C) different from the first air gesture. In some embodiments, in response to detecting the fifth air gesture, in accordance with a determination that the fifth air gesture is in a third direction (e.g., left or right, as discussed with respect to hand 216 in FIGS. 2A-2B), the first computer system changes a fifth setting (e.g., an image of photo user interface 202, as discussed above with respect to FIG. 2D) of a first device (e.g., 206) different from the first computer system. In some embodiments, the fifth setting is different from the first setting. In some embodiments, the fifth setting is the same as the first setting. In some embodiments, in response to detecting the fifth air gesture, in accordance with a determination that the fifth air gesture is in a fourth direction (e.g., up or down, as discussed with respect to hand 216 in FIGS. 2A-2B) different from the third direction, the first computer system changes a sixth setting (e.g., an image of photo user interface 202, as discussed above with respect to FIG. 2D) of a second device (e.g., 200) different from the first device. In some embodiments, the sixth setting is different from the fifth setting. In some embodiments, the sixth setting is the same as the fifth setting. Changing settings of different devices based on a direction of an air gesture enables a user to have more control with air gestures relative to a particular surface, allowing settings of different devices to be changed by changing the direction of the air gesture, thereby performing an operation when a set of conditions has been met without requiring further user input, providing additional control options without cluttering the user interface with additional displayed controls, and/or providing improved feedback to the user.

In some embodiments, in response to detecting the first air gesture and in accordance with the determination that the first air gesture is performed relative to the third surface, the first computer system changes a seventh setting (e.g., of the control) (e.g., as discussed above with respect to FIGS. 2A-2C) different from the first setting. Changing the seventh setting in response to detecting the first air gesture when the first air gesture is performed relative to the third surface enables the first computer system to automatically change a specific setting based on the surface the gesture was performed relative to, thereby performing an operation when a set of conditions has been met without requiring further user input, providing additional control options without cluttering the user interface with additional displayed controls, and/or providing improved feedback to the user.

In some embodiments, the control is a first control. In some embodiments, in response to detecting the first air gesture and in accordance with the determination that the first air gesture is performed relative to the third surface, the first computer system changes a second control (and/or a setting of the second control) different from the first control. Changing the second control in response to detecting the first air gesture and in accordance with the determination that the first air gesture is performed relative to the third surface enables the first computer system to automatically change a specific control based on the surface the gesture was performed relative to, thereby performing an operation when a set of conditions has been met without requiring further user input, providing additional control options without cluttering the user interface with additional displayed controls, and/or providing improved feedback to the user.

In some embodiments, after detecting the first air gesture, the first computer system detects, via the one or more input devices, a sixth air gesture (e.g., as discussed with respect to hand 216 in FIGS. 2A, 2B, and/or 2C) different from the first air gesture. In some embodiments, in response to detecting the sixth air gesture, in accordance with a determination that the sixth air gesture is a third type of air gesture, the first computer system changes an eighth setting of a third control. In some embodiments, the eighth setting is different from the first setting. In some embodiments, the third control is different from the first control. In some embodiments, in response to detecting the sixth air gesture, in accordance with a determination that the sixth air gesture is a fourth type of air gesture different from the third type of air gesture, the first computer system changes a ninth setting of a fourth control, wherein the fourth control is different from the third control (and/or the first control). In some embodiments, the ninth setting is different from the first setting. In some embodiments, the ninth setting is the same as the eighth setting. Changing settings of different controls based on detecting different types of air gestures enables the first computer system to automatically change a specific control based on the type of gesture performed, thereby performing an operation when a set of conditions has been met without requiring further user input, providing additional control options without cluttering the user interface with additional displayed controls, and/or providing improved feedback to the user.

In some embodiments, after changing the first setting of the control in accordance with the determination that the first air gesture is performed relative to the first surface, the first computer system detects, via the one or more input devices, a first request (e.g., as discussed with respect to FIG. 2D) to change a configuration of one or more surfaces. In some embodiments, after detecting the first request to change the configuration of the one or more surfaces, the first computer system detects, via the one or more input devices, a seventh air gesture (e.g., as discussed with respect to FIG. 2D) different from the first air gesture. In some embodiments, in response to detecting the seventh air gesture and in accordance with a determination that the seventh air gesture is performed relative to the first surface, the first computer system forgoes change of (e.g., as discussed with respect to FIG. 2D) the first setting of the control. In some embodiments, the seventh air gesture is separate from the first air gesture and the same as the first air gesture. In some embodiments, in response to detecting the seventh air gesture and in accordance with a determination that the seventh air gesture is performed relative to the second surface, the first computer system forgoes change of the first setting of the control. Changing configuration of one or more surfaces to cause a surface that previously changed a setting to no longer change a setting enables a user to pick and choose how to use surfaces in their environment, thereby performing an operation when a set of conditions has been met without requiring further user input, providing additional control options without cluttering the user interface with additional displayed controls, and/or providing improved feedback to the user.

In some embodiments, after detecting the first air gesture (e.g., in accordance with the determination that the first air gesture is performed relative to the first surface and/or the second surface) and forgoing change of the first setting of the control in response to detecting the first air gesture, the first computer system detects, via the one or more input devices, a second request (e.g., as discussed with respect to FIG. 2D) to change a configuration of one or more surfaces. In some embodiments, after detecting the second request to change the configuration of the one or more surfaces, the first computer system detects, via the one or more input devices, an eighth air gesture (e.g., as discussed with respect to FIG. 2D) different from the first air gesture. In some embodiments, in response to detecting the eighth air gesture and in accordance with a determination that the eighth air gesture is performed relative to the third surface, the first computer system changes (e.g., as discussed with respect to FIG. 2D) the first setting of the control. Configuring the third surface to change the first setting of the control enables a user to pick and choose how to use surfaces in their environment, thereby performing an operation when a set of conditions has been met without requiring further user input, providing additional control options without cluttering the user interface with additional displayed controls, and/or providing improved feedback to the user.

In some embodiments, the one or more input devices include one or more cameras (e.g., a telephoto camera, a wide-angle camera, and/or an ultra-wide-angle camera). In some embodiments, detecting the first air gesture is performed using the one or more cameras.

Note that details of the processes described above with respect to method 300 (e.g., FIG. 3) are also applicable in an analogous manner to other methods described herein. For example, method 400 optionally includes one or more of the characteristics of the various methods described above with reference to method 300. For example, changing the first setting of the control of method 300 can be causing the first device to perform an operation of method 400. For brevity, these details are not repeated below.

FIG. 4 is a flow diagram illustrating a method (e.g., method 400) for responding to input in accordance with some embodiments. Some operations in method 400 are, optionally, combined, the orders of some operations are, optionally, changed, and some operations are, optionally, omitted.

As described below, method 400 provides an intuitive way for responding to input. Method 400 reduces the cognitive burden on a user for interacting with computer systems, thereby creating a more efficient human-machine interface. For battery-operated computing devices, enabling a user to interact with computer systems faster and more efficiently conserves power and increases the time between battery charges.

In some embodiments, method 400 is performed at a computer system (e.g., the controller device as described herein) that is in communication with one or more input devices (e.g., a camera, a depth sensor, and/or a microphone). In some embodiments, the computer system is an accessory, a controller, a fitness tracking device, a watch, a phone, a tablet, a processor, a head-mounted display (HMD) device, and/or a personal computing device.

The computer system detects (402), via the one or more input devices (e.g., via one or more cameras), a first input (e.g., a tap input and/or a non-tap input (e.g., a voice command or request, a swipe input, a hold-and-drag input, a gaze input, an air gesture, and/or a mouse click)) (e.g., as discussed with respect to hand 216 in FIGS. 2A, 2B, and/or 2C) directed to a control (e.g., a user element and/or component configured to provide functionality) (e.g., display of an image as discussed above with respect to FIGS. 2A-2D) (e.g., 212 and/or 214) associated with (and/or established with, corresponding to, and/or set for) a first device (e.g., a second computer system) (e.g., 200 or 206) and a second device (e.g., a third computer system) (e.g., 200 or 206) different from the first device. In some embodiments, the computer system is in communication with the first device and/or the second device. In some embodiments, the computer system is not in communication with the first device and/or the second device while detecting the first input. In some embodiments, the first device and/or the second device is an accessory, a controller, a fitness tracking device, a watch, a phone, a tablet, a processor, a head-mounted display (HMD) device, and/or a personal computing device.

In response to (404) detecting the first input, in accordance with a determination that the first input is in a first direction (e.g., starts at a first location and moves to a second location that is at least partially in the first direction from the first location) (e.g., left or right, as discussed above with respect to FIGS. 2A-2C), the computer system causes (406) the first device to perform an operation (e.g., a first operation) (e.g., change image in photo user interface 208) without causing the second device to perform an operation (e.g., a second operation) (e.g., change image in photo user interface 202). In some embodiments, the computer system causing the first to perform an operation includes the computer system connecting with the first device and sending to the first device a request to perform an operation. In some embodiments, the second operation is the same as the first operation. In some embodiments, the second operation is a different type of operation than the first operation.

In response to (404) detecting the first input, in accordance with a determination that the first input is in a second direction (e.g., up or down, as discussed above with respect to FIGS. 2C-2D) different from the first direction, the computer system causes (408) the second device to perform an operation (e.g., the second operation) (e.g., change image in photo user interface 202) without causing the first device to perform an operation (e.g., the first operation) (e.g., change image in photo user interface 208). Causing the first device to perform an operation in accordance with the determination that the input is in the first direction and/or causing the second device to perform an operation in accordance with the determination that the input is in the second direction allows the computer system to choose the correct device to perform an operation based on the direction of the input, thereby reducing the number of inputs needed to perform an operation, providing additional control options without cluttering the user interface with additional displayed controls, and/or performing an operation when a set of conditions has been met without requiring further user input.

In some embodiments, the second direction is perpendicular to the first direction. In some embodiments, the first direction (e.g., starts from a first location and moves to a second location different from the first location) and the second direction (e.g., starts from a third location and moves to a fourth location different from the third location) intersect each other (e.g., at a 90-degree angle). In some embodiments, the second direction is vertical (starts from a fifth location and moves to a sixth location (e.g., different from the fifth location) below or above the fifth location). In some embodiments, the first direction is horizontal (e.g., starts from a seventh location and moves to an eighth location (e.g., different from the seventh location) to the right or the left of the seventh location). In some embodiments, the second direction is horizonal. In some embodiments, the first direction is vertical. In some embodiments, the first direction is up and down. In some embodiments, the second direction is left and right. In some embodiments, the first direction is in the x direction. In some embodiments, the second direction is in the y direction.

In some embodiments, the second direction is opposite of the first direction. In some embodiments, the second direction is moving towards the left and the first direction is moving towards the right. In some embodiments, the second direction is moving towards the right and the first direction is moving towards the left. In some embodiments, the second direction is upwards and the first direction is downwards. In some embodiments, the second direction is downwards and the first direction is upwards. In some embodiments, the second direction is moving away from the first direction. In some embodiments, the first direction is parallel to the second direction. In some embodiments, the second direction is in a reverse direction (e.g., up and down, counterclockwise and clockwise, and/or left and right) of the first direction.

In some embodiments, the first device is a first type of device (e.g., a television, a multi-media device, an accessory, a speaker, a lighting fixture, and/or a personal computing device). In some embodiments, the second device is a second type of device different from the first type of device. In some embodiments, the first type of device corresponds to a device having a first set of one or more components. In some embodiments, the second type of device corresponds to a device having a second set of one or more components different from the first set of one or more components. In some embodiments, the first type of device corresponds to a device with a first set of one or more features and/or functionalities. In some embodiments, the second type of device corresponds to a device with a second set of one or more features and/or functionalities different from the first set of one or more features and/or functionalities.

In some embodiments, the first device is a third type of device. In some embodiments, the second device is the third type of device (e.g., the same type of device as the first device). In some embodiments, the third type of device corresponds to a device having a third set of one or more components. In some embodiments, the third type of device corresponds to a device with a third set of one or more features and/or functionality.

In some embodiments, in response to detecting the first input and in accordance with a determination that the first input is in a third direction different from the first direction and the second direction, the computer system causes the first device and the second device to perform an operation (e.g., the computer system causes the first device to perform the first operation and the computer system causes the second device to perform the second operation). In some embodiments, the operation of the first device and the operation of the second device are the same. In some embodiments, the operation of the first device is different from the operation of the second device. In some embodiments, the operation of the first device and the operation of the second device occur at least partially (or entirely) simultaneously. In some embodiments, the operation of the first device and the operation of the second device do not occur simultaneously. In some embodiments, causing the first device and the second device to perform an operation includes connecting with the first device and/or the second device. In some embodiments, causing the first device and the second device to perform an operation includes sending to the first device and/or the second device a request to perform an operation. Causing both the first device and the second device to perform an operation in accordance with the determination that the input is in the third direction of the input allows the user to control multiple devices and allows the computer system to cause both devices to perform an operation, thereby reducing the number of inputs needed to perform an operation, providing additional control options without cluttering the user interface with additional displayed controls, and/or performing an operation when a set of conditions has been met without requiring further user input.

In some embodiments, in response to detecting the first input and in accordance with a determination that the first input is in a fourth direction different from the first direction and the second direction (and/or the third direction), the computer system forgoes cause of the first device and the second device to perform an operation (e.g., the computer system forgoes causing the first device to perform an operation and the computer system forgoes causing the second device to perform an operation) (e.g., the computer system foregoes causing the first device to perform the first operation and the computer system forgoes causing the second device to perform the second operation). In some embodiments, in response to detecting the first input and in accordance with a determination that the first input is in the fourth direction, the computer system performs an operation while causing neither the first device nor the second device to perform an operation. In some embodiments, in response to detecting the first input and in accordance with a determination that the first input is in the fourth direction, the computer system also does not perform an operation. Causing both the first device and the second device to not perform an operation in accordance with the determination that the input is in the fourth direction provides the user with control over the devices only in particular directions and not others, thereby performing an operation when a set of conditions has been met without requiring further user input.

In some embodiments, the control corresponds to a surface (e.g., a surface (e.g., a front surface, a side surface, and/or a back surface) within a field of view of the one or more input devices) (e.g., 212 and/or 214). In some embodiments, the surface is different from (e.g., not included in, not corresponding to, and/or separate from) the first device and the second device. In some embodiments, the surface is a touch sensitive surface. In some embodiments, the surface is not a touch sensitive surface. In some embodiments, the surface is a physical item (e.g., a coaster, a remote, and/or a pen). In some embodiments, the surface is different from (e.g., not included in, not corresponding to, and/or separate from) the computer system.

In some embodiments, the control is not included in (e.g., not detected on, not detected by, not part of, and/or not a portion of) the first device. In some embodiments, the control is not included in (e.g., not detected on, not detected by, not part of, and/or not a portion of) the second device. In some embodiments, the first input is detected via one or more cameras (e.g., the first input is detected in one or more images captured by the one or more cameras).

In some embodiments, after detecting the first input in the first direction (and/or causing the first device to perform an operation in response to detecting the first input and in accordance with a determination that the first input is in the first direction), the computer system detects a second input (e.g., a tap input and/or a non-tap input (e.g., a swipe input, a hold-and-drag input, a gaze input, an air gesture, and/or a mouse click)) (e.g., directed to the control associated with the first device and the second device) (e.g., as discussed with respect to hand 216 in FIGS. 2A, 2B, and/or 2C) in the second direction. In some embodiments, after detecting the first input in the first direction, the computer system detects the second input. In some embodiments, the second input is in the second direction. In some embodiments, in response to detecting the second input in the second direction (and/or in accordance with a determination that the second input is in the second direction), the computer system causes the second device to perform an operation (e.g., the second operation) (e.g., change image in photo user interface 202) without causing the first device to perform an operation (e.g., the first operation) (e.g., change image in photo user interface 208). Causing the second device to perform an operation in accordance with the determination that the second input is in the second direction after the determination that the first input is in the first direction allows the computer systems to control different devices depending a direction of an input, thereby reducing the number of inputs needed to perform an operation and performing an operation when certain condition are met.

In some embodiments, the first input includes an air gesture (e.g., a hand input to pick up, a hand input to press, an air tap, an air swipe, and/or a clench and hold air input) (e.g., as discussed above with respect to hand 216).

Note that details of the processes described above with respect to method 400 (e.g., FIG. 4) are also applicable in an analogous manner to other methods described herein. For example, method 300 optionally includes one or more of the characteristics of the various methods described above with reference to method 400. For example, the first computer system of method 300 can be the computer system of method 400. For brevity, these details are not repeated below.

FIG. 5 is a flow diagram illustrating a method (e.g., method 500) for responding to input in accordance with some embodiments. Some operations in method 500 are, optionally, combined, the orders of some operations are, optionally, changed, and some operations are, optionally, omitted.

As described below, method 500 provides an intuitive way for responding to input. Method 500 reduces the cognitive burden on a user for interacting with computer systems, thereby creating a more efficient human-machine interface. For battery-operated computing devices, enabling a user to interact with computer systems faster and more efficiently conserves power and increases the time between battery charges.

In some embodiments, method 500 is performed at a computer system (e.g., the controller device discussed herein) that is in communication with one or more input devices (e.g., a camera, a depth sensor, and/or a microphone). In some embodiments, the computer system is an accessory, a controller, a fitness tracking device, a watch, a phone, a tablet, a processor, a head-mounted display (HMD) device, and/or a personal computing device.

While (502) the computer system is operating in a first mode (e.g., context, state, and/or setting) (e.g., the first mode discussed above with respect to FIGS. 2A-2D), the computer system detects (504), via the one or more input devices, a first input (e.g., a tap input and/or a non-tap input (e.g., a swipe input, a hold-and-drag input, a gaze input, an air gesture, and/or a mouse click)) (e.g., as discussed with respect to hand 216 in FIGS. 2A, 2B, and/or 2C) directed to a first location (and/or area) on a first surface (e.g., an outside, an exterior, a side, and/or an outward portion) (e.g., 212 and/or 214). In some embodiments, the surface is part of a computer system and/or a device. In some embodiments, the surface is separate and/or different from a computer system and/or a device. In some embodiments, the first surface includes an input device. In some embodiments, the first surface does not include an input device. In some embodiments, an input device of the first surface detects the first air gesture. In some embodiments, the one or more input devices are separate and/or different from the surface. In some embodiments, the first mode includes a set of one or more predefined areas and/or surfaces that, when detecting input relative to the set of one or more predefined areas and/or surfaces, the computer system is set to control one or more devices.

While (502) the computer system is operating in the first mode, in response to detecting the first input directed to the first location on the first surface, the computer system causes (506) a first device (e.g., a second computer system) (e.g., 200 and/or 206) to perform a first operation (e.g., change an image of photo user interface 202 and/or 208), wherein the first device is different from the computer system. In some embodiments, the first device is an accessory, a controller, a fitness tracking device, a watch, a phone, a tablet, a processor, a head-mounted display (HMD) device, and/or a personal computing device. In some embodiments, the first device is an accessory, a controller, a fitness tracking device, a watch, a phone, a tablet, a processor, a head-mounted display (HMD) device, and/or a personal computing device.

While (502) the computer system is operating in the first mode, after causing the first device to perform the first operation, the computer system detects (508), via the one or more input devices, a second input (e.g., a tap input and/or a non-tap input (e.g., a swipe input, a hold-and-drag input, a gaze input, an air gesture, and/or a mouse click)) including an air gesture (e.g., a tap gesture, a pinch gesture, a swipe gesture, selection gesture, and/or a non-selection gesture). In some embodiments, the second input is the air gesture.

In response to detecting the second input (and/or the air gesture), the computer system switches (510) to operating from the first mode to a second mode (e.g., the second mode discussed above with respect to FIGS. 2A-2D) different from the first mode.

While (512) the computer system is operating in the second mode, the computer system detects (514), via the one or more input devices, a third input (e.g., a tap input and/or a non-tap input (e.g., a swipe input, a hold-and-drag input, a gaze input, an air gesture, and/or a mouse click)) (e.g., as discussed with respect to hand 216 in FIGS. 2A, 2B, and/or 2C) directed to the first location on the first surface.

While (512) the computer system is operating in the second mode, in response to detecting the third input directed to the first location on the first surface, the computer system causes (516) a second device (e.g., a third computer system) (e.g., 200 and/or 206) to perform a second operation, wherein the second device is different from the computer system and the first device. In some embodiments, the second device is an accessory, a controller, a fitness tracking device, a watch, a phone, a tablet, a processor, a head-mounted display (HMD) device, and/or a personal computing device. Switching to operating from the first mode to a second mode different from the first mode in response to detecting the second input allows a user to use the same surface in more than one mode to, in some embodiments, control different devices, thereby providing improved feedback to the user, providing additional control options without cluttering the user interface with additional displayed controls, performing an operation when a set of conditions has been met without requiring further user input, and/or allowing the computer system to avoid burn-in of the display generation component. Causing a second device to perform a second operation in response to detecting the third input directed to the first location on the first surface allows a user to control more than one device using the same location on the surface depending on which mode the computer system is operating in, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, the first input corresponds to a first type of input (e.g., a gesture type including one or more gestures) (e.g., touch input and/or gesture via a touch-sensitive surface, audio and/or voice via a microphone, air gesture via a camera, button press via a button, and/or rotation via a rotatable input mechanism) (e.g., an input gesture (e.g., to input text and/or a voice command), a navigation gesture (e.g., a swipe gesture to scroll through a menu of items, a pinching gesture to zoom in or out of a view, and/or a gaze gesture to select an item in the display), and/or an action gesture (e.g., tap or wave gestures used to perform actions such as opening files, launching apps, closing windows, and/or configuring a surface)). In some embodiments, the second input corresponds to a second type of input different from the first type of input. Having the first input correspond to a first type of input and the second input correspond to a second type of input different from the first type of input allows the computer system to map each type of input to a particular operation, thereby providing improved feedback to the user, performing an operation when a set of conditions has been met without requiring further user input, and/or increasing security.

In some embodiments, the first input includes an air gesture. In some embodiments, the second input includes an air gesture. In some embodiments, the first device is a first type of device (e.g., a watch, a phone, a tablet, a fitness tracking device, a processor, a head-mounted display (HMD) device, a communal device, a media device, a speaker, a television, a personal computing device, a smart TV, smart light, smart thermostat, smart lock, smart doorbell, speaker, security camera, smart vacuum, smart sprinkler system). In some embodiments, the computer system is a second type of device different from the first type of device. Having the first device be a first type of device and the computer system be a second type of device different from the first type of device provides a user with the ability to have operations be performed by the computer system on devices of different types, thereby performing an operation when a set of conditions has been met without requiring further user input and/or increasing security.

In some embodiments, the first device is a third type of device. In some embodiments, the second device is the third type of device. In some embodiments, the first and second devices are the same type of device, including utility, command type, and/or output type (e.g., the first and second devices are a smart light and/or the first and second devices are a smart TV). In some embodiments, switching to operating from the first mode to the second mode includes switching control from the first device to the second device (e.g., a device of the same type). Having the first device be a third type of device and the second device be the third type of device provides a user with the ability to have a set of operations be performed on similar devices, thereby providing improved visual feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, the second operation is the first operation (e.g., the second operation is the same as the first operation) (e.g., the second operation is the same type as the first operation). In some embodiments, the first input and the third input cause the same operation to be performed on their respective devices (e.g., the first input causes a first light to turn off and the third input causes a second light, different from the first light, to turn off). In some embodiments, different modes do not change a type of operation performed by a respective device in response to detecting a particular input. Having the second operation be the first operation allows a user to have the same operation be performed on different devices in different modes, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, the first operation is a first type of operation (e.g., display operation, determination operation, communication operation, detection operation, output operation, playback operation, and/or haptic operation). In some embodiments, the second operation is a second type of operation different from the first type of operation. In some embodiments, different modes cause inputs directed at the same location on a surface to perform different operations by a respective device in response to detecting a particular input. In some embodiments, the second operation being a second type of operation different from the first type of operation allows a user to have different operations be performed in response to each input directed at the same location relative to the surface, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, while the computer system is operating in the first mode, the computer system detects, via the one more input devices, a fourth input (e.g., a tap input and/or a non-tap input (e.g., a swipe input, a hold-and-drag input, a gaze input, an air gesture, and/or a mouse click)) directed to a second location on the first surface, wherein the second location is different (and/or separate) from the first location. In some embodiments, while the computer system is operating in the first mode, in response to detecting the fourth input directed to the second location on the first surface, the computer system causes a third operation to be performed, wherein the third operation is different from the first operation. In some embodiments, the first surface has one or more locations, wherein inputs directed to different locations perform different types of operations. Causing a third operation to be performed in response to detecting the fourth input directed to the second location on the first surface, wherein the third operation is different from the first operation, allows a user to perform different operations in a single mode using different locations of the surface, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, causing the third operation to be performed includes causing the first device to perform the third operation (e.g., the third operation corresponds to (is performed by) the first device). In some embodiments, the third operation is performed by one or more devices including the first device and one or more other (e.g., similar, same, or different types of devices). Causing the third operation to be performed including causing the first device to perform the third operation allows a user to cause more than one operation to be performed on a single device depending on where input is detected with respect to the surface, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, causing the third operation to be performed includes performing the third operation without causing the first device to perform the third operation (e.g., the computer system performs the third operation without causing the first device and/or another device different from the first device (e.g., not including the computer system) to perform the third operation) (e.g., the third operation corresponds to (is performed by) the computer system) (e.g., the third operation does not correspond to (is not performed by) the first device). In some embodiments, the third operation performs system controls by (on) the computer system (e.g., display controls, storage and data management, applications management, etc.). Causing the third operation to be performed including performing the third operation without causing the first device to perform the third operation allows a user to control the computer system using the same surface as used to control other devices, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, causing the third operation to be performed includes causing a third device, different from the first device and the computer system (and/or the second device), to perform the third operation (e.g., the third operation corresponds to the third device). In some embodiments, while operating in the first mode, one or more locations on the first surface perform operations on any device configured to (e.g., predetermined to) be controlled. Causing the third operation to be performed including causing a third device, different from the first device and the computer system, to perform the third operation allows a user to control more than one device using the same surface, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, while the computer system is operating in the second mode, the computer system detects, via the one or more input devices, a fifth input (e.g., a tap input and/or a non-tap input (e.g., a swipe input, a hold-and-drag input, a gaze input, an air gesture, and/or a mouse click)) directed to the second location on the first surface. In some embodiments, while the computer system is operating in the second mode, in response to detecting the fifth input directed to the second location on the first surface, the computer system causes the third operation to be performed (e.g., by the first device, the second device, the computer system, and/or another device different from the first device, the second device, and/or the computer system). In some embodiments, the third operation is preconfigured to be performed in response to detecting an input type (e.g., at a corresponding location with a corresponding air gesture) on the first surface while operating in the first mode and while operating in the second mode. Causing the third operation to be performed in response to detecting the fifth input directed to the second location on the first surface allows a user to perform the same operation by directing an input to the same location on the surface in different modes, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, while the computer system is operating in the second mode, the computer system detects, via the one or more input devices, a sixth input (e.g., a tap input and/or a non-tap input (e.g., a swipe input, a hold-and-drag input, a gaze input, an air gesture, and/or a mouse click)) directed to the second location on the first surface. In some embodiments, while the computer system is operating in the second mode, in response to detecting the sixth input directed to the second location on the first surface, the computer system causes the second device to perform a fourth operation different from the third operation (and/or the first operation and/or the second operation). In some embodiments, while operating in the second mode, the third operation is not preconfigured to be performed in response to detecting an input at the second location on the first surface. Causing the second device to perform a fourth operation different from the third operation in response to detecting the sixth input directed to the second location on the first surface allows a user to perform different operations by directing an input to a single location of the surface depending on a current mode, thereby providing improved visual feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, while the computer system is operating in the first mode, the computer system detects, via the one more input devices, a seventh input (e.g., a tap input and/or a non-tap input (e.g., a swipe input, a hold-and-drag input, a gaze input, an air gesture, and/or a mouse click)) directed to a first location on a second surface different (and/or separate) from the first surface. In some embodiments, while the computer system is operating in the first mode, in response to detecting the seventh input directed to the first location on the second surface, the computer system forgoes cause of the first device to perform the first operation. In some embodiments, while operating in the first mode, the first device is not preconfigured to perform an operation of the input type corresponding to the seventh input directed at the first location on the second surface. Forgoing causing the first device to perform the first operation in response to detecting the seventh input directed to the first location on the second surface while operating in the first mode allows the computer system to restrict operations and only respond to inputs corresponding to a particular surface, thereby performing an operation when a set of conditions has been met without requiring further user input and/or increasing security.

In some embodiments, while the computer system is operating in the second mode, the computer system detects, via the one or more input devices, an eighth input (e.g., a tap input and/or a non-tap input (e.g., a swipe input, a hold-and-drag input, a gaze input, an air gesture, and/or a mouse click)) directed to a second location on the second surface. In some embodiments, while the computer system is operating in the second mode, in response to detecting the eighth input directed to the second location on the second surface, the computer system forgoes cause of the second device to perform the second operation. In some embodiments, while operating in the second mode, the second device is not preconfigured to perform the second operation (and/or any operation) of the input type corresponding to the eighth input directed at the second location on the second surface. Forgoing causing the second device to perform the second operation in response to detecting the eighth input directed to the second location on the second surface while operating in the second mode allows the computer system to restrict operations and only respond to inputs corresponding to a particular surface, thereby performing an operation when a set of conditions has been met without requiring further user input and/or increasing security.

In some embodiments, while the computer system is operating in the second mode, the computer system detects, via the one or more input devices, a ninth input (e.g., a tap input and/or a non-tap input (e.g., a swipe input, a hold-and-drag input, a gaze input, an air gesture, and/or a mouse click)) directed to a third location (e.g., the second location and/or another location different from the second location) on the second surface. In some embodiments, while the computer system is operating in the second mode, in response to detecting the ninth input directed to the third location on the second surface, the computer system forgoes cause of the first device to perform the first operation. In some embodiments, while operating in the second mode, the first device is not preconfigured to perform the first operation (and/or any operation) of the input type corresponding to the ninth input directed at the third location on the second surface. Forgoing causing the first device to perform the first operation in response to detecting the ninth input directed to the third location on the second surface while operating in the second mode allows the computer system to restrict operations and only respond to inputs corresponding to a particular surface, thereby performing an operation when a set of conditions has been met without requiring further user input and/or increasing security.

In some embodiments, while the computer system is operating in the second mode, the computer system detects, via the one or more input devices, a tenth input (e.g., a tap input and/or a non-tap input (e.g., a swipe input, a hold-and-drag input, a gaze input, an air gesture, and/or a mouse click)) directed to a fourth location (e.g., the third location, the second location, and/or another location different from the third location and/or the second location) on the second surface. In some embodiments, while the computer system is operating in the second mode, in response to detecting the tenth input directed to the fourth location on the second surface, the computer system causes the first device (and/or another device) to perform the first operation. In some embodiments, the fourth location on the second surface is configured to cause the first device to perform the first operation. Causing the first device to perform the first operation in response to detecting the tenth input directed to the fourth location on the second surface allows a user to preconfigure an operation on more than one surface, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, while the computer system is operating in the second mode, the computer system detects, via the one or more input devices, an eleventh input (e.g., a tap input and/or a non-tap input (e.g., a swipe input, a hold-and-drag input, a gaze input, an air gesture, and/or a mouse click)) directed to a fifth location on the second surface. In some embodiments, while the computer system is operating in the second mode, in response to detecting the eleventh input directed to the fifth location on the second surface, the computer system causes a fourth device to perform a fifth operation, wherein the fourth device is different from the first device and the computer system. Causing a fourth device to perform a fifth operation in response to detecting the eleventh input directed to the fifth location on the second surface, wherein the fourth device is different from the first device and the computer system allows a user to configure different surfaces to correspond to different devices, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, the first input corresponds to a third type of input. In some embodiments, the third input corresponds to the third type of input (e.g., both the first and third inputs are wave inputs and/or both the first and third inputs are swipe inputs). In some embodiments, the third type of input causes the second device to perform an operation of the same type as an operation performed by the first device. Having the first input correspond to a third type of input, and having the third input correspond to the third type of input allows a user to preconfigure the same type of input to perform different operations in different modes, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

In some embodiments, the second input corresponds to a fourth type of input different from the third type of input (and/or the third type of input) (e.g., the second input is a wave input and the third input is a swipe input). In some embodiments, the fourth type of input causes the second device to perform the second operation that is of a different type from the first operation performed by the first device. Having the second input correspond to a fourth type of input different from the third type of input provides a user with the ability to use one type of input to change modes and a different type of input to cause devices to perform operations, reducing the risk of accidentally performing an unintentional operation, thereby providing improved feedback to the user, performing an operation when a set of conditions has been met without requiring further user input, and/or increasing security.

In some embodiments, the air gesture is a first air gesture. In some embodiments, while the computer system is operating in the second mode, the computer system detects, via the one or more input devices, a twelfth input (e.g., a tap input and/or a non-tap input (e.g., a swipe input, a hold-and-drag input, a gaze input, an air gesture, and/or a mouse click)) including a second air gesture. In some embodiments, while the computer system is operating in the second mode, in response to detecting the twelfth input, in accordance with a determination that the second air gesture is a first type, the computer system switches to operating from the second mode to a third mode different from the second mode (and/or the first mode). In some embodiments, while the computer system is operating in the second mode, in response to detecting the twelfth input, in accordance with a determination that the second air gesture is a second type different from the first type, the computer system switches to operating from the second mode to a fourth mode different from the second mode and the third mode (and/or the first mode). In some embodiments, the fourth mode is configured differently than the third mode. In some embodiments, detecting the same input at the same location while the computer system is operating in the third mode causes a different operation to be performed than while the computer system is operating in the fourth mode. In some embodiments, while the computer system is operating in the third mode, the computer system detects, via the one or more input devices, a thirteenth input (e.g., a tap input and/or a non-tap input (e.g., a swipe input, a hold-and-drag input, a gaze input, an air gesture, and/or a mouse click)) directed to a first location on a third surface (e.g., the first location on the first surface, another location on the first surface, and/or a location on another surface different from the first surface). In some embodiments, while the computer system is operating in the third mode, in response to detecting the thirteenth input directed to the first location on the third surface, the computer system performs a sixth operation (e.g., with or without causing another device to perform an operation). In some embodiments, while the computer system is operating in the fourth mode, the computer system detects, via the one or more input devices, a fourteenth input (e.g., a tap input and/or a non-tap input (e.g., a swipe input, a hold-and-drag input, a gaze input, an air gesture, and/or a mouse click)) directed to the first location on the third surface, wherein the fourteenth input is the same as the thirteenth input. In some embodiments, while the computer system is operating in the fourth mode, in response to detecting the fourteenth input directed to the first location on the third surface, the computer system performs a seventh operation (e.g., with or without causing another device to perform an operation) different from the sixth operation. Different air gestures causing the computer system to switch to operate in different modes, and accordingly control one or more devices differently with one or more surfaces, allows a user more control, flexibility, and/or freedom in establishing different configurations that can be switched between at a point in time depending on a gesture used, thereby providing improved feedback to the user, reducing the number of inputs needed to perform an operation, providing additional control options without cluttering the user interface with additional displayed controls, performing an operation when a set of conditions has been met without requiring further user input, increasing security, and/or allowing the computer system to avoid burn-in of the display generation component.

In some embodiments, the air gesture is a third air gesture. In some embodiments, while the computer system is operating in the second mode, the computer system detects, via the one or more input devices, a fifteenth input (e.g., a tap input and/or a non-tap input (e.g., a swipe input, a hold-and-drag input, a gaze input, an air gesture, and/or a mouse click)) including a fourth air gesture different from the third air gesture. In some embodiments, the fourth air gesture is the same type of air gesture as the third air gesture. In some embodiments, the fourth air gesture is a different type of air gesture than the third air gesture. In some embodiments, in response to detecting the fifteenth input (and/or the fourth air gesture), the computer system switches to operating from the second mode to the first mode. In some embodiments, the fifteenth input corresponds to the first type of input. In some embodiments, the fifteenth input forgoes configuring (creating) a new surface (e.g., the fourteenth input reconfigures the first surface). Switching back to operating to the first mode in response to detecting the fifteenth input provides a user with the flexibility of switching back to a previous mode, thereby providing improved feedback to the user, providing additional control options without cluttering the user interface with additional displayed controls, performing an operation when a set of conditions has been met without requiring further user input, and/or allowing the computer system to avoid burn-in of the display generation component.

In some embodiments, the computer system detects, via the one or more input devices, a sixteenth input (e.g., of a fifth type, different from a type of input of the first input, the second input, and/or the third input) (e.g., directed to a third location on the first surface) (e.g., while the computer system is operating in the first mode and/or the second mode) (e.g., a tap input and/or a non-tap input (e.g., a swipe input, a hold-and-drag input, a gaze input, an air gesture, and/or a mouse click)). In some embodiments, in response to detecting the sixteenth input, the computer system performs an eighth operation (e.g., with or without causing another device to perform an operation). In some embodiments, while operating in the first mode and/or while operating in the second mode, different input types are preconfigured to perform the same operation (e.g., while operating in the first mode, a wave gesture causes a third light to turn on and while operating in the second mode, a wave gesture causes a fourth light (or the third light) to turn on). Performing an eighth operation in response to detecting the sixteenth input provides a user with the simplicity of having a single operation to be performed in response to detecting the same input in more than one mode, thereby providing improved feedback to the user, reducing the number of inputs needed to perform an operation, providing additional control options without cluttering the user interface with additional displayed controls, performing an operation when a set of conditions has been met without requiring further user input, and/or allowing the computer system to avoid burn-in of the display generation component.

Note that details of the processes described above with respect to method 500 (e.g., FIG. 5) are also applicable in an analogous manner to the methods described herein. For example, method 300 and/or method 400 can optionally include one or more of the characteristics of the various methods described above with reference to method 500. For example, changing the first set of the control of method 300 can be causing the first device to perform the first operation of method 500 or causing the second device to perform the second operation of method 500. For another example, causing the first device to perform an operation of method 400 can be causing the first device to perform the first operation of method 500 or causing the second device to perform the second operation of method 500. For brevity, these details are not repeated below.

The operations described above can be performed using various ecosystems of devices. Conceptually, a source device obtains and delivers data representing the environment to a decision controller. In the foregoing examples, for instance, an accessory device in the form of a camera acts as a source device by providing camera output about the environment described above with respect to FIGS. 2A-2D, 3, 4, and/or 5. The camera output can be provided to a controller device with sufficient computation power to process the incoming information and generate instructions for other devices in the environment. Examples of electronic devices having sufficient computational power to act as controllers include a smart phone, a smart watch, a smart display, a tablet, a laptop, a head-mounted display device, and/or a desktop computer. Controller functionality may also be integrated into devices that have other primary functionalities, such as a media playback device, a smart speaker, a tabletop dock or smart screen, and/or a television. Source devices, such as the camera, can in some instances have sufficient computational power to act as controller devices. It should be appreciated that computational power generally represents a design choice that is balanced with power consumption, packaging, and/or cost. For example, a source device that is wired to main electricity may be more likely to take on controller device functionality than a battery-powered device, even though both are possible. The controller device, upon determining a decision based on the obtained sensor output, provides instructions to be processed by one or more other devices in the environment (e.g., first computer system 200 and/or second computer system 206). In the foregoing examples, the controller device causes first computer system 200 or second computer system 208 to display different images.

The various ecosystems of devices described above can connect and communicate with one another using various communication configurations. Some exemplary configurations involve direct communications such as device-to-device connections. For example, a source device (e.g., camera) can capture images of an environment, determine an air gesture performed by a particular subject and, acting as a controller device, determine to send an instruction to a computer system to change states. The connection between the source device and the computer system can be wired or wireless. The connection can be a direct device-to-device connection such as Bluetooth. Some exemplary configurations involve mesh connections. For example, a source device may use a mesh connection such as Thread to connect with other devices in the environment. Some exemplary configurations involve local and/or wide area networks and may employ a combination of wired (e.g., Ethernet) and wireless (e.g., Wi-Fi, Bluetooth, Thread, and/or UWB) connections. For example, a camera may connect locally with a controller hub in the form of a smart speaker, and the smart speaker may relay instructions remotely with a smart phone, over a cellular or Internet connection.

As described above, the present technology contemplates the gathering and use of data available from various sources, including cameras, to improve interactions with connected devices. In some instances, these sources may include electronic devices situated in an enclosed space such as a room, a home, a building, and/or a predefined area. Cameras and other connected, smart devices offer potential benefit to users. For example, security systems often incorporate cameras and other sensors. Accordingly, the use of smart devices enables users to have calculated control of benefits, include detecting air gestures, in their environment. Other uses for sensor data that benefit the user are also contemplated by the present disclosure. For instance, health data may be used to provide insights into a user's general wellness.

Entities responsible for implementing, collecting, analyzing, disclosing, transferring, storing, or otherwise using camera images or other data containing personal information should comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, camera images or personal information data. For example, in the case of device control services, the present technology can be configured to allow users to select to “opt in” or “opt out” of participation during registration for services or anytime thereafter. In another example, users can selectively enable certain device control services while disabling others. For example, a user may enable detecting air gestures with depth sensors but disable camera output.

Implementers may also take steps to anonymize sensor data. For example, cameras may operate at low resolution for automatic object detection, and capture at higher resolutions upon explicit user instruction. Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., name and location), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

What is claimed is:

1. A method, comprising:
at a first computer system that is in communication with one or more input devices:
detecting, via the one or more input devices, a first air gesture; and
in response to detecting the first air gesture:
in accordance with a determination that the first air gesture is performed relative to a first surface, changing a first setting of a control;
in accordance with a determination that the first air gesture is performed relative to a second surface different from the first surface, changing the first setting of the control; and
in accordance with a determination that the first air gesture is performed relative to a third surface different from the first surface and the second surface, forgoing changing the first setting of the control.

2. The method of claim 1, further comprising:
after detecting the first air gesture, detecting, via the one or more input devices, a second air gesture separate from the first air gesture; and
in response to detecting the second air gesture:
in accordance with a determination that the second air gesture is performed relative to a fourth surface and that a first subject performed the second air gesture, performing a first operation; and
in accordance with a determination that the second air gesture is performed relative to the fourth surface and that a second subject different from the first subject performed the second air gesture, performing a second operation different from the first operation.

3. The method of claim 1, wherein:
performing the first air gesture relative to the first surface includes performing the first air gesture within a first predefined distance from the first surface;
performing the first air gesture relative to the second surface includes performing the first air gesture within a second predefined distance from the second surface; and
performing the first air gesture relative to the third surface includes performing the first air gesture within a third predefined distance from the third surface.

4. The method of claim 1, wherein the first surface is separate from the first computer system, wherein the second surface is separate from the first computer system, and wherein the third surface is separate from the first computer system.

5. The method of claim 1, wherein the first computer system includes the first surface, the second surface, or the third surface.

6. The method of claim 1, wherein the first setting of the control corresponds to a second computer system different from the first computer system, and wherein the second computer system includes the first surface, the second surface, or the third surface.

7. The method of claim 1, wherein the control corresponds to the first computer system.

8. The method of claim 1, wherein the control corresponds to a third computer system different from the first computer system.

9. The method of claim 1, further comprising:
after detecting the first air gesture, detecting, via the one or more input devices, a third air gesture different from the first air gesture; and
in response to detecting the third air gesture and in accordance with a determination that the third air gesture is performed relative to the first surface, changing a second setting of the control, wherein the second setting is different from the first setting.

10. The method of claim 9, wherein the third air gesture is a different type of air gesture than the first air gesture.

11. The method of claim 1, further comprising:
after detecting the first air gesture, detecting, via the one or more input devices, a fourth air gesture different from the first air gesture; and
in response to detecting the fourth air gesture:
in accordance with a determination that the fourth air gesture is in a first direction, changing a third setting; and
in accordance with a determination that the fourth air gesture is a second direction different from the first direction, changing a fourth setting different from the third setting.

12. The method of claim 1, further comprising:
after detecting the first air gesture, detecting, via the one or more input devices, a fifth air gesture different from the first air gesture; and
in response to detecting the fifth air gesture:
in accordance with a determination that the fifth air gesture is in a third direction, changing a fifth setting of a first device different from the first computer system; and
in accordance with a determination that the fifth air gesture is a fourth direction different from the third direction, changing a sixth setting of a second device different from the first device.

13. The method of claim 1, further comprising:
in response to detecting the first air gesture and in accordance with the determination that the first air gesture is performed relative to the third surface, changing a seventh setting different from the first setting.

14. The method of claim 1, wherein the control is a first control, the method further comprising:
in response to detecting the first air gesture and in accordance with the determination that the first air gesture is performed relative to the third surface, changing a second control different from the first control.

15. The method of claim 1, further comprising:
after detecting the first air gesture, detecting, via the one or more input devices, a sixth air gesture different from the first air gesture; and
in response to detecting the sixth air gesture:
in accordance with a determination that the sixth air gesture is a third type of air gesture, changing an eighth setting of a third control; and
in accordance with a determination that the sixth air gesture is a fourth type of air gesture different from the third type of air gesture, changing a ninth setting of a fourth control, wherein the fourth control is different from the third control.

16. The method of claim 1, further comprising:
after changing the first setting of the control in accordance with the determination that the first air gesture is performed relative to the first surface, detecting, via the one or more input devices, a first request to change a configuration of one or more surfaces;
after detecting the first request to change the configuration of the one or more surfaces, detecting, via the one or more input devices, a seventh air gesture different from the first air gesture; and
in response to detecting the seventh air gesture and in accordance with a determination that the seventh air gesture is performed relative to the first surface, forgoing changing the first setting of the control.

17. The method of claim 1, further comprising:
after detecting the first air gesture and forgoing changing the first setting of the control in response to detecting the first air gesture, detecting, via the one or more input devices, a second request to change a configuration of one or more surfaces;
after detecting the second request to change the configuration of the one or more surfaces, detecting, via the one or more input devices, an eighth air gesture different from the first air gesture; and
in response to detecting the eighth air gesture and in accordance with a determination that the eighth air gesture is performed relative to the third surface, changing the first setting of the control.

18. The method of claim 1, wherein the one or more input devices include one or more cameras, and wherein detecting the first air gesture is performed using the one or more cameras.

19. A non-transitory computer-readable storage medium storing one or more programs configured to be executed by one or more processors of a first computer system that is in communication with one or more input devices, the one or more programs including instructions for:
detecting, via the one or more input devices, a first air gesture; and
in response to detecting the first air gesture:
in accordance with a determination that the first air gesture is performed relative to a first surface, changing a first setting of a control;
in accordance with a determination that the first air gesture is performed relative to a second surface different from the first surface, changing the first setting of the control; and
in accordance with a determination that the first air gesture is performed relative to a third surface different from the first surface and the second surface, forgoing changing the first setting of the control.

20. A first computer system that is in communication with one or more input devices, comprising:
one or more processors; and
memory storing one or more programs configured to be executed by the one or more processors, the one or more programs including instructions for:
detecting, via the one or more input devices, a first air gesture; and
in response to detecting the first air gesture:
in accordance with a determination that the first air gesture is performed relative to a first surface, changing a first setting of a control;
in accordance with a determination that the first air gesture is performed relative to a second surface different from the first surface, changing the first setting of the control; and
in accordance with a determination that the first air gesture is performed relative to a third surface different from the first surface and the second surface, forgoing changing the first setting of the control.
